(19) United States
(12) Patent Application Publication
(10) Pub. No.: US 2026/0346155 A1
(43) Pub. Date: Nov. 5, 2026

(54) SYSTEM AND METHOD FOR GROUPED WIRELESS BROADCAST IN A TOY OR EDUCATIONAL SYSTEM

(71) Applicant: LEGO A/S, Billund (DK)

(72) Inventors: René Christensen WELLEJUS, Billund (DK); Mads Møller JENSEN, Billund (DK); Gregory Ross STEVENS, Billund (DK); Anders Bang POULSEN, Billund (DK)

(73) Assignee: LEGO A/S, Billund (DK)

(21) Appl. No.: 19/486,569

(22) PCT Filed: Jun. 21, 2024
(86) PCT No.: PCT/EP2024/067483

§ 371 Date: Nov. 21, 2025

(30) Foreign Application Priority Data
Jun. 23, 2023 (DK) PA202370335

(51) Int. Cl. A63H 33/04; H04W 4/08; H04W 4/80; H04W 12/03; H04W 12/76; H04W 72/30

(52) U.S. Cl. CPC A63H 33/042; H04W 12/03; H04W 12/76; A63H 2200/00; H04W 4/08; H04W 4/80; H04W 72/30

(57) ABSTRACT

A toy or educational system includes multiple wireless elements configured to communicate through a broadcast network and a group token storing group configuration data with a unique identifier. Each wireless element has a reader that obtains the configuration data when the group token is within a readable proximity. In response, transmitting elements embed a group identifier derived from the token in broadcast messages, and receiving elements accept only messages carrying the same identifier. The wireless elements thereby form a broadcast group that selectively exchanges data independent of other groups without pairing procedures. The group token may define additional parameters such as group labels, encryption keys, or programmed instructions for common behavior. The system enables rapid and intuitive grouping of modular wireless elements for interactive play or educational use, supporting multiple non-interfering teams or functional assemblies operating concurrently within the same wireless environment.

### CROSS-REFERENCE TO RELATED APPLICATIONS

The present application is a U.S. National Stage Application of International Application No. PCT/EP2024/067483, filed on Jun. 21, 2024, entitled “SYSTEM AND METHOD FOR GROUPED WIRELESS BROADCAST IN A TOY OR EDUCATIONAL SYSTEM,” which claims the benefit of and priority to Danish Patent Application No. PA202370335, filed on Jun. 23, 2023, each of which is incorporated herein by reference in its entirety.

### FIELD OF THE DISCLOSURE

The present disclosure relates in one aspect to a toy or educational system, i.e. a system adapted for toy or educational use, wherein the system comprises a plurality of wireless elements adapted to communicate with each other through a broadcast network. At least a first one of the wireless elements comprises a wireless transmitter adapted to broadcast data messages through one or more wireless channels of the broadcast network. At least a second one of the wireless elements comprises a wireless receiver adapted to receive data messages through the one or more wireless channels of the broadcast network. The first and second wireless elements are grouped in a broadcast group to selectively communicate with each other.

Advantageously according to some aspects, the disclosure further relates to a toy or educational system comprising a plurality of wireless elements comprising a transmitter adapted to broadcast data messages through one or more wireless channels, and a plurality of wireless elements having a receiver comprising a wireless receiver adapted to receive data messages through the one or more wireless channels.

According to a further aspect, the disclosure relates to a method of grouping a plurality of wireless elements in a broadcast group, wherein a first one of the wireless elements comprises a wireless transmitter adapted to broadcast data messages through one or more wireless channels, and wherein a second one of the wireless elements comprises a wireless receiver adapted to receive data messages through the one or more wireless channels.

Advantageously according to some aspects, a plurality of separate broadcast groups may be formed, each broadcast group comprising a plurality of wireless elements, wherein the wireless elements are configured to selectively participate in the respective broadcast group.

According to a particularly advantageous aspect, the wireless elements are modular construction elements of a modular construction system.

### BACKGROUND OF THE DISCLOSURE

Modular toy elements and educational systems exploiting the advantages of modular toy systems for enhanced learning and play experiences have been known and appreciated for years. Systems for use as toys and/or for educational purposes may include a large variety of interacting/cooperating elements of different functionality, which may be arranged, combined, and assembled for use in a playful and educational experience. Such playful and educational experience may involve multiple users at the same time. Moreover such playful and educational experiences may often be set up and held for multiple user groups at the same time. Such users and/or user groups may work, play and act together in many different settings, e.g. a science class, a playful STEM/STEAM education program, a constructional competition, a robotics challenge, a role playing game, an amusement park or otherwise themed entertainment, treasure hunts, or simply a group of users meeting up for creative play. Depending on the setting, users of such systems may thus include children and learners of all ages.

Known systems of toy or educational systems often use wired connections to link the different elements, such as switches, sensors, motors, light, and/or sound emitters, controllers, and processors together. While useful, these wired connections may sometimes be challenging, or even limiting, for the possibilities of freely combining the different interacting and/or cooperating elements of the system with each other. As a result, the implementation of certain play or educational experiences may simply not be possible.

In some toy systems, such as wand dueling or role playing systems, this has been addressed by using wireless communication to link elements of a play system together. However, these systems typically fail to address issues of high data traffic load and interference, as more and more elements are added to the system, or when many users participate in the playful and educational experience. Such systems using wireless elements typically also fail to address issues of unintentional crosstalk between different elements of the system, or interference with other devices using the same wireless communication infrastructure. When creating a functional toy construction model, when solving an educational challenge, or when setting up an interactive play experience using interacting wireless elements, some users may also have a need to divide a set of interacting wireless elements into multiple subsets, in order to facilitate selective interaction of wireless elements in one subset without interfering with other subsets of wireless elements. For example, users may desire to define functional sub-groups of a more complex machine, or to define team subsets of devices in an interactive play experience with multiple teams.

Common to settings involving multiple interacting or cooperating elements in a toy or educational system is therefore a need to facilitate selective interaction within one subset of elements (e.g. elements belonging to one user group, construction model, or play set) without interfering with other subsets of wireless elements (e.g. wireless elements belonging to other users, another construction model, or another play set). Furthermore, there is a need for an improved user friendly set-up routine that allows for easy management of multiple groups involving multiple participants or groups of participants, each working with a respective set of wireless elements.

### SUMMARY OF THE DISCLOSURE

The above-mentioned challenges may be solved according to embodiments of the present disclosure by configuring the wireless elements to communicate with each other in a wireless broadcast network, thereby facilitating fast and instantaneous sharing of data without the need of complying with complex registration or pairing protocols. More particularly, broadcast is configured to be selective within broadcast groups, each broadcast group comprising at least one wireless element with a transmitter and at least one wireless element with a receiver. The broadcast groups are defined in a simple and effective manner by using respective group tokens, wherein both transmitters and receivers are grouped using the same group token.

The disclosure is defined by the appended independent claims, with advantageous embodiments as disclosed in the dependent claims, and as further disclosed in the following. Thereby, an easy, flexible and effective set-up routine is achieved, as also further detailed in the following.

A first aspect of the disclosure relates to a toy or educational system comprising:
a plurality of wireless elements, wherein a first one of the wireless elements comprises a wireless transmitter adapted to broadcast data messages through one or more wireless channels, wherein a second one of the wireless elements comprises a wireless receiver adapted to receive data messages through the one or more wireless channels; and
a group token carrying group configuration data;
wherein each of the first and second wireless elements further comprises a reader adapted to obtain group configuration data stored on the group token, wherein the first wireless element is configured, upon reading group configuration data from the group token, to set a group identifier of the first wireless element to a common group identifier based on the group configuration data read from the group token, wherein the first wireless element is configured to include the common group identifier in a transmitted data message, wherein the second wireless element is configured, upon reading group configuration data from the group token, to set a group identifier of the second wireless element to the common group identifier based on the group configuration data read from the group token, and wherein the second wireless element is configured to select received data messages that include the common group identifier. Thereby, the first and second wireless elements are grouped in a broadcast group using the same group token.

The plurality of wireless elements thus comprises at least one first wireless element, such as one, two, three, or more first wireless elements, each of the first wireless elements comprising at least a wireless transmitter. The plurality of wireless elements furthermore comprises at least one second wireless element, such as one, two, three, or more second wireless elements, each of the second wireless elements comprising at least a wireless receiver. One or more of the first wireless elements, in addition to the respective wireless transmitter, may also comprise a wireless receiver. A first wireless element comprising a wireless receiver may also be operated as a second wireless element. Correspondingly, one or more of the second wireless elements, in addition to the respective wireless receiver, may also comprise a wireless transmitter. A second wireless element comprising a wireless transmitter may also be operated as a first wireless element. Furthermore, it may also be noted that reference to the first and second wireless elements not necessarily implies a particular sequence of reading configuration data from the same group token. First and second wireless elements may thus obtain configuration data from the group token one after the other in any sequence, simultaneously, or in any combination of sequential and simultaneous reading of the configuration data from the group token, by the first and second wireless elements.

Typically, obtaining group configuration data from the group token occurs by reading or otherwise transferring the configuration data from the group token to the reader of a wireless element. The reader may be any suitable device adapted to receive the configuration data from the group token. Advantageously, the respective wireless element reads the configuration data responsive to fulfilment of a pre-determined condition. Advantageously, the wireless element reads the configuration data automatically when the group token is brought within a reading distance of the wireless element. As further detailed below, the reader may use a proximity reading technique, requiring to bring the group token and the one or more wireless elements in proximity of each other. The reading distance may be a predetermined proximity of the group token and the wireless element. Starting the reading process may be conditioned by a pre-determined criterion for successfully obtaining group configuration data from the group token, such as a criterion for distinguishing between successful and unsuccessful reading. For example, such a criterion may be based on an indication of the distance between the group token and the wireless element, the received signal strength, a signal to noise level of the signal received at the reader, or the like.

The group token may be any suitable device adapted to store configuration data and to transfer the stored configuration data from the group token to the wireless elements. The group token may be adapted to initiate the transfer of configuration data to a wireless element. Alternatively or in addition thereto, the group token may be adapted to receive a query for configuration data from a wireless element, and to provide the configuration data to the wireless element in response to the received query. As further detailed below, the transfer of configuration data may be initiated by a gesture, such as bringing the group token in proximity of one or more of the wireless elements. Alternatively or in addition thereto, obtaining the configuration data from the group token may be subject to other conditions, such as based on a pre-determined criterion for distinguishing between successful and unsuccessful reading as discussed above. In some embodiments, one or more, and preferably each of the wireless elements of the system may therefore be configured to detect such a gesture with regard to a group token, and to determine fulfilment of a corresponding condition concerning the transfer of configuration data.

The data messages may be broadcast using one or more data channels of a given wireless infrastructure with hardware and software that is compliant with a pre-defined wireless communication protocol, such as infrastructure compliant with Bluetooth 5, Bluetooth BLE, ZigBee, Z-wave, or a similar radiofrequency broadcast infrastructure. When the transmitter of a first wireless element transmits a data message through one or more broadcast channels of a given wireless infrastructure, the group identifier assigned to the first wireless element by a group token is included in the data message. When the receiver of a second wireless element receives the data message through the one or more given broadcast channels, only those data messages are selected that include the group identifier that has been assigned to the second wireless element.

Even though the transmitting first wireless elements transmit data messages through broadcast channels in a given wireless communication infrastructure that may also accommodate other wireless transmission, the communication within the same broadcast group is selective, since the receiving second wireless elements only select those of the received data messages that carry the common group identifier of the broadcast group. Any subsequent processing at the second elements is only performed on the selected messages. Thereby, the processing tasks to be performed at the second element in a crammed wireless transmission environment are largely reduced to only act on data messages relevant for the broadcast group.

The selective communication is achieved without requiring any time-consuming pairing between the transmitting first wireless elements and the receiving second wireless elements each time a broadcast group is set up or modified. The minimum pre-shared information required for setting up the selective communication of the wireless elements in a broadcast group is the common group identifier, which is assigned to both transmitting and receiving elements simply by reading group configuration data from a corresponding group token. Furthermore, an easy, flexible and efficient modification of the broadcast group becomes possible by addition or removal of wireless elements, whether these are acting as transmitters, receivers, or both. Such changes may even be made dynamically in operation, i.e. without interruption due to a re-initialization of a set or subset of wireless elements, since information is shared by between the wireless elements in a broadcast group, where the transmitters do not require knowledge about further wireless elements in order transmit a data message, and the receivers do not require further knowledge of other wireless elements in order receive and select a data message, as long as the wireless elements participating in a given broadcast group are configured with the same group identifier.

In so far the group identifier of the first and second wireless elements match, they share a common group identifier, which has been assigned to them by means of the same group token. By using the same group token for assigning the common group identifier to both the first wireless elements acting as transmitter and the second wireless elements acting as receiver, the first and second wireless elements are grouped together in a broadcast group in a simple, flexible, and efficient manner.

When setting up a broadcast group including both transmitters and receivers, the same, or at least a corresponding, procedure of assigning a group identifier by using a group token is applied to all wireless elements participating in said broadcast group. The procedure is adapted for being applied in a simple gesture performed by a user. Thereby, a high flexibility and modularity is achieved for defining and redefining broadcast group constellations in an easy and effective manner. This is particularly useful in a toy or educational system where wirelessly interacting elements are to be used and combined in a creative and intuitive manner to solve tasks or to facilitate a playfully stimulating experience. Furthermore, this is particularly useful in a modular toy or educational construction system, where also ease of use, flexibility, and modularity are important for forming different constellations of wirelessly interacting construction elements, in order to facilitate a satisfying and stimulating user experience when constructing models with varying degrees of functionality and at all levels of experience.

Advantageously according to some embodiments the toy or educational system includes multiple different group tokens. Thereby, multiple different broadcast groups can be defined. As a result, an improved handling of multiple groups of wireless elements is achieved. This is particularly useful when a set of wireless elements of the toy or educational system is to be divided into multiple subsets, e.g. for use by multiple teams of users, or for use as functional subgroups in a more complex assembly.

Further according to some embodiments, the system includes multiple wireless elements comprising a transmitter module. Further according to some embodiments, the system includes multiple second wireless elements comprising a receiver module. Further according to some embodiments, the system includes wireless elements comprising both a transmitter module and a receiver module. Such wireless elements are thus adapted to act both as a first wireless element and as a second wireless element. By providing a multitude of transmitter and/or receiver elements, the variety and complexity of assignments and assemblies that can be catered by the system is largely increased.

According to some embodiments, the group token is configured for replacing an existing broadcast group configuration of a wireless element with a new configuration according to configuration data stored on the group token, when the configuration data is read onto the wireless element. By configuring a group token to replace an existing configuration when reading the new configuration stored on the group token onto a wireless element, broadcast groups of wireless elements may be defined that exclusively share information within the broadcast group of the group token as determined by the configuration data of said group token. Using multiple different group tokens, separate broadcast groups of wireless elements can thus be defined. A separate broadcast group thus defined is isolated from other broadcast groups and wireless elements in this separate broadcast group cannot interact or interfere with wireless elements in other broadcast groups.

According to some embodiments of a toy or educational system, the isolation of a first broadcast group may be superseded by a requirement imposed on some or all wireless elements of the first broadcast group to participate in one or more additional broadcast groups. Such an additional requirement of overlapping or nested broadcast groups may be achieved by first configuring a plurality of wireless elements as members of a first broadcast group using a first group token, and subsequently adding a further broadcast group configuration to the existing first broadcast group configuration of the wireless element using an additional group token.

In some embodiments, a fully separate broadcast grouping may even be imposed on a system configuration level. For example, one or more, or each of the wireless elements may be configured to only accept assignment to one broadcast group at a time. Thereby, a radically simple constellation is imposed in a manner, which is simple to understand by the user, thereby lowering an entry barrier for using the system, thus facilitating a successful and satisfying user experience.

A low entry barrier may be particularly useful in a context where longer explanations on the correct use of the system may be prohibitive for a successful and satisfying use of the system for its intended use, such as for playfully interactive educational purposes. A low entry barrier may also be particularly useful in a context where ease of use is of the essence, such as for educational use in short self-contained sessions, for unexperienced users of interactive toy systems, or for making interactive toy and educational systems accessible to a broader user group of unexperienced users, like for younger children.

Advantageously, such a limitation to operation in separate broadcast groups may be combined with a simple broadcast protocol architecture, where any payload data is also transmitted in the same one or more communication channels as the grouping information. For example, grouping information (e.g. a group identifier) may be included in a header portion of a broadcast message and associated payload data may be attached in a body portion of the broadcast message as discussed elsewhere herein. The grouping information and the associated payload data may e.g. be broadcast by transmitting wireless elements on multiple broadcast channels in parallel, for example using one or more, such as two, three, or more advertising channels of a wireless communication infrastructure like Bluetooth, BLE, or similar. The grouping information and the associated payload data may thus be broadcast at an increased rate using multiple broadcast channels in parallel, such as through the mentioned advertising channels. In some embodiments, the grouping information and the associated payload data may be broadcast at a rate of at least 1 Hz, such as at least 5 Hz, such as at least 10 Hz, or about 20 Hz. In some embodiments, a practical upper limit for the transmission rate may be up to 200 Hz, such as up to 100 Hz, such as up to 50 Hz.

The receiving wireless elements may be configured to monitor multiple broadcast channels in parallel, such as the above-mentioned advertising channels, for relevant messages, i.e. messages having matching group information, and if a match is found, to also receive any associated payload data through this channel for subsequent processing. Monitoring may be configured such that the receiving wireless elements listen to any or all of the relevant broadcast channels in a continuous manner and/or at discrete intervals. In some embodiments, a listening rate and/or duration may be adapted to ensure prompt and reliable reception at the receiving wireless elements of transmissions originating from the transmitting wireless elements.

Furthermore, such a simplified broadcast protocol may prioritize distributing payload data with a predetermined maximum length and/or which are response time critical. More extensive data and/or data that is not (or less) critical to responsiveness in an interactive user experience may then be transferred through other channels and/or communication modes. For example in some embodiments, firmware update data or otherwise lengthy data may be exempted from broadcast through such grouped broadcast channels (or at least assigned low priority). Instead, such data transfers may be transferred from a processing device (e.g. a smart device or a personal computer) to a wireless element in a paired or connected communication mode. A radically simplified approach imposing separate broadcast groups thus also allows to reduce lag in interaction response among grouped wireless elements despite potentially severe restrictions in processing power, memory, and/or communication bandwidth. Thereby, a satisfying user experience can be achieved even under severe cost constraints and performance limitations typically encountered in toy or educational systems.

According to some embodiments, one or more group tokens of the toy or educational system are configured for adding a new configuration to an existing broadcast group configuration of a wireless element, wherein the new configuration is added according to configuration data stored on the group token, when the configuration data is read onto the wireless element. Assigning and configuring the wireless element as a member of a new broadcast group may thus be performed in an additive manner, adding the new group configuration from an additional group token to the existing configuration already applied to the wireless elements using a first group token. The wireless element is thus configured for operation in both the first and additional broadcast groups.

Overlapping and/or nested broadcast groups may be particularly useful in a scenario where broadcast groups need to share a common functionality. The common functionality may be linked to the collection of input, and subsequent broadcasting using a transmitter module of the shared wireless element. The common functionality may also be linked to the generation of user-perceptible output, in response to receiving and selecting a data message using a receiver module of the shared wireless element. The added broadcast group configuration may further include a hierarchical ranking of the broadcast groups. Thereby a large variety of complexity of functional links between wireless elements can be constructed.

In so far only a subset including some, but not all, of the wireless members of the first broadcast group are configured as members of the one or more additional broadcast groups, the first and additional broadcast groups are referred to as overlapping. By providing a constellation of overlapping broadcast groups, the broadcast groups can be configured to share information and functionality through the wireless elements that the broadcast groups have in common. For instance, one or more common wireless transmitter elements may be provided in order to provide common data to all of the overlapping broadcast groups. By way of example, the common data may include sensor or user input to both broadcast groups, such as a common timer, a common reset switch, a common start/stop button (e.g. for activation by a tutor or referee), a common remote control user input sensor, or the like. Alternatively or in addition thereto, the intersection of the overlapping broadcast groups may also include one or more common wireless receiver elements adapted to accept data messages from wireless transmitter elements in any of the overlapping broadcast groups, and provide a corresponding response. By way of example, the response to the received and selected data message may be as diverse as the collection of a score count, or the triggering of a motion, sound, and/or light response in a common game piece by a signal generated in and transmitted by a wireless element in the complementary (non-overlapping) parts of the broadcast groups.

In so far all of the wireless members of the first broadcast group are configured as members of the one or more additional broadcast groups, the first broadcast group is nested within the one or more additional broadcast groups. The first broadcast group is thus a subset of the one or more additional broadcast groups, and the one or more additional broadcast groups hosting the first broadcast group are supersets to the first broadcast group.

A nested constellation where all the wireless elements of the first broadcast group are added as members to the superset at equal footing may de facto behave as if the broadcast groups were merged. This may be further superseded in the configuration of a wireless element by imposing a requirement of hierarchical order of multiple broadcast groups assigned to the wireless element. According to some embodiments, the configuration data may further comprise programmed instructions indicating a hierarchical level of the group token. A hierarchically overlapping and/or nested broadcast group constellation may, for example, be useful when some wireless elements are to be assigned a master role vis-á-vis multiple separate broadcast groups, such as a master clock, a timer, a stop function that should stop all activity at once, a locking/unlocking function, a referee function, an overall score board function, or the like. For example, multiple separate first level broadcast groups may all be nested within an additional broadcast group. The additional broadcast group may then act as a master level broadcast group for sharing information with all wireless elements of the additional group and of all nested first level broadcast groups. However, data messages broadcast by wireless elements that are only member of a nested first level group are only shared with the remaining members of the first level broadcast group and with the wireless elements exclusively member of the master level group, but not with any of the members of the other separate first level broadcast groups.

It may be noted that in some embodiments of a toy or educational system, a master broadcast group may be pre-configured into all wireless elements of the toy or educational system, e.g. by pre-configuring all wireless elements as members of a pre-defined master broadcast group. This allows to selectively only configure the wireless elements intended for operation at a higher hierarchical level (master level) as members of the higher hierarchical level broadcast group using a higher hierarchical level group token (master group token), in case a hierarchical structure is desired, instead of having to apply a master group token to all wireless elements of a given toy or educational system.

The wireless elements include a processor with programmed instructions controlling the behavior of the wireless element. The programmed instructions may be written to, modified, or replaced in order to program the behavior of the wireless elements. The wireless elements may read programmed instructions included in configuration data from the group token. Alternatively or in addition thereto, the wireless elements may be configured to read such programmed instructions from a dedicated programming token that may be provided separately. Furthermore according to some embodiments, the toy or educational system may include a programming interface operated on a separate device, such as a personal computer, a tablet computer, a mobile phone, or a similar smart device, which may connect to the processor of the wireless elements through the reader device, through transmitter and receiver modules, or through a dedicated wired or wireless programming port. Programming of the wireless elements may also be performed via the intermediate of a rewritable group token or programming token, by creating a program on a separate device, transferring the program from the separate device to the group or programming token, and then read the program from the token to the wireless element using the reader of the wireless element.

Further according to some embodiments of the system, the group token is a radio frequency identification tag and the reader is a radio frequency identification reader. According to some embodiments the group token is a near field communication tag and the reader is a near field communication reader. Further according to some embodiments of the system the radio frequency identification tag is a powerless tag, i.e. a tag receiving power from the reader during a reading process. Thereby, a reliable and low-cost token can be provided. By way of example, the group token may be a physical item, such as in the form of a card, with a passive RFID tag inside. Advantageously according to some embodiments of the system, group tokens are not formed as modular construction elements, in order to easily distinguish these group tokens from modular construction elements to be used by users for solving a given project.

According to some embodiments, a pre-determined reading distance between a wireless element and a group token for successfully reading the group configuration data stored on the group token is less than 1 m, or less than 0.5 m, or less than 0.2 m, or less than 0.1 m. More particularly, according to some embodiments, a pre-determined reading distance between a wireless element and a group token for successfully reading the group configuration data stored on the group token is less than 10 cm, less than 5 cm, or even less than 2 cm. Advantageously according to some embodiments, the reader is configured as a proximity reader. Further advantageously, the reader is adapted to discriminate between accepting and not accepting a reading from a group token according to a pre-determined distance. Further according to some embodiments, the reader is adapted to discriminate between accepting and not accepting a reading from a group token according to a pre-determined threshold for a reading signal strength. Further according to some embodiments, the reader is adapted to discriminate between accepting and not accepting a reading from a group token according to a pre-determined timing requirement. By limiting the reading process to proximity reading, a distinctive user gesture is facilitated for transferring configuration data from a group token to one or more selected wireless elements. Such a distinctive user gesture enables the user of the system to perform the broadcast group configuration in an intuitive manner. Furthermore, well-defined requirements for a successful reading ensure that the reading process is reliable and predictable, thereby further adding to the intuitive nature of the gesture.

Further according to some embodiments of the system, the group configuration data comprises a unique identifier of the group token and the common group identifier is based on the unique identifier of the group token. The group IDENTIFIER may be a unique identifier of the group token, such as a unique identifier of an RFID tag included in the group token, or a sufficiently distinctive portion of said unique identifier allowing for a reliable distinction between different group tokens. A distinctive group identifier may also be derived from a unique identifier of the group token by applying a hash algorithm to the unique identifier. An appropriate hash algorithm, or another suitable set of rules for deriving the group identifier from a unique identifier of the group token, may be included in all wireless elements of a given system, system set, or system subset. By deriving a group identifier from the unique identifier of the group token, a simple, reliable and secure procedure of determining the group identifier is achieved, at low processing complexity.

Further according to some embodiments of the system, the group configuration data further comprises a group label; and one or more of the first and second wireless elements comprise a status indicator configured to produce a user-perceptible output indicative of the group label.

Advantageously, the group token further comprises a user-perceptible representation indicative of the group label. Responsive to reading the group configuration data at the first and/or second wireless element, a group label status of said first and/or second wireless elements may be set to the common group label. Said first and/or second wireless elements may then produce a corresponding user-perceptible status output representative of the group label on a status indicator thereof. Advantageously according to some embodiments of the system, the status indicator is a light-emitter, such as an LED. Advantageously according to some embodiments, the group identification label refers to a color, and the light emitter is adapted to emit a status color corresponding to the group identification color.

The group label is typically less distinctive then the actual group identifier. However, the group label may nevertheless give a user-distinguishable indication of the group identity of a group token and the wireless elements that have been configured as members of the associated broadcast group. By including a group label in the configuration data, the group label may be reliably transferred to each wireless element reading the configuration data from the group token. Furthermore, the wireless element may give a user-perceptible indication of a broadcast group configuration status based on that group label. This indication may be sufficient for the user to assert correct broadcast group configuration and distinguish between different broadcast groups in the vicinity.

Further according to some embodiments of the system, the first wireless element is an input element comprising an input device adapted to produce input device output data representative of an input thereto. Advantageously according to some embodiments the input device is a sensor. A sensor may include a switch, a user-operable input device, a position sensor, a proximity sensor, a motion sensor, an acceleration sensor, a pressure sensor, a light sensor, a temperature sensor, a touch sensor, a microphone, or the like. The input device is useful for collecting data from the environment, such as data from measurements of one or more physical quantities and/or user input. The collected data can be shared selectively by broadcasting the data, or a data message based on the collected data, within the broadcast group, or broadcast groups, to which the first wireless element adheres. The shared data may be for useful for controlling operation of one or more, or any, of the other elements in the broadcast group.

Advantageously according to some embodiments of the system, the first wireless element is further configured to transmit the input device output data in a body portion of the data message, said data message being broadcast in one or more advertising channels. Thereby, a well-structured, yet simple and reliable protocol for sharing low volume data is provided, with low exigence as to the broadcast infrastructure.

Advantageously according to some embodiments of the system, the data message transmitted by the first wireless element comprises a header portion and a body portion. Advantageously in some embodiments, the header portion comprises the common group identifier. Further advantageously in some embodiments, the body portion carries pay load data, such as input device output data and/or programmed instructions. By including the group identifier in a header portion, the transmitted data messages can easily be selected at a receiving element, with low processing power requirements.

In some embodiments of the system, the body portion carries a pointer identifying transmission of pay load data in separate data packages. Furthermore, the first wireless element may be configured to transmit a pointer in a body portion of the data message, said data message being broadcast in one or more advertising channels, said pointer identifying transmission of the output data in separate data packages. Thereby, a well-structured, yet simple and reliable protocol for sharing larger volume data is provided, allowing to separate the transmission of the group identity of a transmitted message from the transmission of larger volume data transfer. This allows for reducing the load on the broadcast infrastructure in the case of larger volume data broadcast, or optimizing the load distribution and throughput in the available broadcast infrastructure.

In some embodiments of the system, the data packages are broadcast in a data channel different from the one or more advertising channels. Furthermore, the above-mentioned pointer may point to a transmission of the payload data in a separate channel, such as a data channel associated with the advertising channels. Furthermore, the pointer may comprise a channel identifier and timing information for the transmission of the payload data in the separate channel. Thereby, a well-structured and reliable protocol for sharing high volume data is provided, which allows for separating the transmission of the group identity of a transmitted message from the transmission of high volume payload data. Thereby further reducing the load on the broadcast infrastructure in the case of high volume data broadcast, or optimizing the load distribution and throughput in a broadcast infrastructure supporting multiple channels.

Further according to some embodiments of the system, the second wireless element is a function element comprising a function device and a control circuit adapted to control the function device to produce a user-perceptible output. Data messages received and selected for subsequent processing at the second wireless element may thus be used to control user-perceptible output based on payload data in the selected data messages. The pay load data may comprise input device output data and/or programmed instructions. The programmed instructions may also be based on, associated with, or selected according to input device output data. Thereby, wireless elements with basic functionality are provided, which allow for creating more complex functionalities. As a consequence, an easy and intuitively to use toy or educational system is achieved that allows to freely build new functionalities from basic functional elements that are functionally linked together through wireless exchange of information in well-defined groups. Such functional assemblies may thus be created at any desired level of complexity in an easy and intuitive manner, using wireless elements in one or more broadcast groups as defined by corresponding group tokens. Furthermore, the creation of such new functionality is not limited by whether or not the basic functional elements are physically connected to any of the other functional elements within a given broadcast group. Furthermore, this effect is achieved particularly in combination with the above-mentioned wireless input elements, which may thus be functionally interlinked with any of the other wireless input and/or function elements within a given broadcast group to create new functionality.

The function device is adapted to produce user perceptible output, such as motion, display/light, or sound/audio. Advantageously, a control circuit/processor controls the function device in response to the payload data in the selected data messages. Thereby, a variety of basic functions may be provided, which may be functionally linked together with other wireless elements in one or more broadcast groups by using corresponding group tokens, to create new functionality.

Further according to some embodiments, the system is a modular toy or educational construction system comprising modular construction elements, the modular construction elements comprising coupling members for detachably connecting the modular construction elements to each other so as to construct a toy or educational construction model. Preferably, the wireless elements do not comprise electrical contacts directly accessible on the outside of their housing. Advantageously a re-chargeable power supply may be included in the wireless elements. The re-chargeable power supply may be adapted for wireless recharging. Further preferably, no electrical contacts are arranged in association with the coupling members of the modular construction system, such that the electrical contacts would make contact when the coupling members are engaged. In some embodiments, a housing of the wireless elements is made of, or fully encapsulated with an electrically insulating material.

Further according to some embodiments of the system, at least one, or two, or more, or all of the wireless elements are modular construction elements. Advantageously, coupling members of wireless modular construction elements in the toy or educational system are also made of an electrically insulating material. By providing the wireless elements as construction elements, in particular modular construction elements that may be detachably connected to each other through cooperating coupling members, the new functionality of interlinked wireless elements within a broadcast group may be embedded in a physical construction, thereby enhancing a physical construction experience with new functionality in a highly intuitive and user-friendly manner. This effect of an improved physical and functional construction experience is further enhanced by further including conventional modular construction elements in the toy or educational system.

Alternatively or in addition thereto, the wireless elements may also include one or more devices comprising a microcontroller and/or other processing devices, such as so-called single board devices like single board microcontrollers or single board computers typically conceived for educational and prototyping purposes. In some embodiments, the wireless elements may also include a processing device like a smart device (e.g. tablet or smart phone), or an adequately configured personal computer. The microcontroller or processing device to be used in or as a wireless element may comprise, or communicate with, an associated reader as well as a transmitter and/or a receiver, and may be configured to act as an input element and/or as a function element. The microcontroller or processing device, e.g. provided in the form of a single board device, may thus also be assigned to a broadcast group using a respective group token, and operated in that broadcast just like any of the other wireless elements. For ease of integration with a modular construction system, the microcontroller and/or processing device may furthermore be mounted as a modular construction element. For example, the microcontroller and/or processing device may be arranged in a housing comprising coupling members that are compatible with the coupling members of the conventional modular construction elements in the set, or may be mounted on a dedicated adapter plate that comprises coupling members that are compatible with the coupling members of the conventional modular construction elements in the set.

Further according to some embodiments of the system, the wireless elements are modular construction elements. Advantageously, coupling members of wireless modular construction elements in the toy or educational system are also made of an electrically insulating material.

Further according to some embodiments of the system, the modular construction system further comprises conventional modular construction elements. Thereby, an improved combined physical and functional construction experience is provided.

Further according to some embodiments of the system, at least a body portion of the message is encrypted using an encryption key (PSK) comprised in the group configuration data.

Advantageously according to some embodiments of the system, the encryption key is derived from a unique identifier of the group token. Thereby, a secure communication between wireless elements in a broadcast group is achieved. By deriving the encryption key for communication in a broadcast group from the unique identifier of the group token used for defining said broadcast group, encryption is configured in a particularly simple and effective, yet secure manner.

Further according to some embodiments of the system, the group token further carries programmed instructions, wherein the first and/or second wireless element is adapted to read the programmed instructions when the group token is within a reading distance of the reader, and to execute the programmed instructions upon reading the programmed instructions from the group token. By including programmed instructions in the configuration data on a group token, all wireless elements can be initialized to a common set of programmed instructions, when reading the configuration from the group token. Thereby, the wireless elements of a broadcast group can be programmed to a common programmed, e.g. to match an assignment, a given task or project, or certain use cases for which the group token has been prepared. Programmed instructions included in the configuration data may also determine whether a configuration read from the group token should be added to or replace an existing configuration, or whether the group token defines a master group with corresponding execution priorities.

Providing programmed instructions to the wireless elements together with the configuration data is also particularly useful when the programmed instructions stored on a group token may be modified, for example using a separate computing device in communication with the group token.

According to a further aspect, whereby corresponding advantages are achieved as discussed above, a system for toy or educational use comprises: a first wireless element having a reader and a wireless transmitter adapted to broadcast data messages through a wireless channel; a second wireless element having a reader and a wireless receiver adapted to receive data messages through the wireless channel; and a group token storing group configuration data including a unique identifier. Each reader is adapted to read the group configuration data stored on the group token when the group token is within a reading distance so that a group identifier of the first and second wireless elements are set to a common group identifier based on the unique identifier. The first wireless element is configured to include the common group identifier in a transmitted data message, and the second wireless element is configured to only process received data messages that include the common group identifier thereby grouping the first and second wireless elements in a broadcast group. The system may further comprise a sorting box having a plurality of compartments, wherein the group token is associated with a first compartment of the compartments to be within the reading distance when the first and second wireless elements are in the first compartment. Further according to some embodiments, the first and second wireless elements require a recognizable gesture in addition to being within the reading distance to accept the group identifier.

While the system thus requires a first wireless element and a second wireless element, such a system for toy or educational use may comprise at least one first wireless element, such as one, two, three, or more first wireless elements, each of the first wireless elements comprising at least a reader and a wireless transmitter. Furthermore, the system for toy or educational use may comprise at least one second wireless element, such as one, two, three, or more second wireless elements, each of the second wireless elements comprising at least a reader and a wireless receiver. The skilled person will understand that one or more of the first wireless elements, in addition to the respective wireless transmitter, may also comprise a wireless receiver. As such, the skilled person will therefore understand that a first wireless element comprising a wireless receiver may also be operated as a second wireless element. Correspondingly, one or more of the second wireless elements, in addition to the respective wireless receiver, may also comprise a wireless transmitter. As such, the skilled person will therefore understand that a second wireless element comprising a wireless transmitter may also be operated as a first wireless element. Furthermore, it may also be noted that reference to the first and second wireless elements not necessarily implies a particular sequence of reading configuration data from the group token. First and second wireless elements may thus obtain configuration data from the group token one after the other in any sequence, simultaneously, or in any combination of sequential and simultaneous reading of the configuration data from the same group token, by the first and second wireless elements.

At least corresponding advantages and effects as discussed above with respect to the toy or educational system are also achieved by the method of grouping a plurality of wireless elements in a broadcast group using a group token as defined in the appended claims, and as described herein.

A second aspect of the disclosure relates to a method of grouping a plurality of wireless elements in a broadcast group using a group token,
each of the wireless elements comprising a reader adapted to read group configuration data stored on the group token;
wherein a first one of the wireless elements comprises a wireless transmitter adapted to broadcast data messages through one or more wireless channels;
wherein a second one of the wireless elements comprises a wireless receiver adapted to receive data messages through the one or more wireless channels; the method comprising:
reading, at the first wireless element, group configuration data from the group token, and setting a group identifier of the first wireless element to a common group identifier based on the group configuration data read from the group token;
configuring the first wireless element to include the common group identifier in a transmitted data message;
reading, at the second wireless element, group configuration data from the group token, and setting a group identifier of the second wireless element to the common group identifier based on
the group configuration data read from the group token; and
configuring the second wireless element to select received data messages that include the common group identifier.

The method thus requires reading configuration data from the group token at a first wireless element and at a second wireless element, and configuring the first and second wireless elements accordingly. As mentioned above, a system for toy or educational use may comprise at least one first wireless element, such as one, two, three, or more first wireless elements, and at least one second wireless element, such as one, two, three, or more first wireless elements, each wireless element comprising a reader. The method steps of reading configuration data from the group token and applying a corresponding configuration may thus be performed at least at one first wireless element, such as at one, two, three, or more first wireless elements, Furthermore, the method steps of reading configuration data from the group token and applying a corresponding configuration may be performed at least at one second wireless element, such as at one, two, three, or more second wireless elements. Each of the first wireless elements comprises at least a reader and a wireless transmitter. Each of the second wireless elements comprising at least a reader and a wireless receiver. However, the skilled person will understand that one or more of the first wireless elements, in addition to the respective wireless transmitter, may also comprise a wireless receiver. As such, the skilled person will therefore understand that a first wireless element comprising a wireless receiver may also be operated as a second wireless element. Correspondingly, one or more of the second wireless elements, in addition to the respective wireless receiver, may also comprise a wireless transmitter. As such, the skilled person will therefore understand that a second wireless element comprising a wireless transmitter may also be operated as a first wireless element. Furthermore, it may also be noted that reference to the first and second wireless elements not necessarily implies a particular sequence of reading configuration data from the same group token. First and second wireless elements may thus obtain configuration data from the group token one after the other in any sequence, simultaneously, or in any combination of sequential and simultaneous reading of the configuration data from the group token, by the first and second wireless elements.

Advantageously according to some embodiments, the method further comprises producing user-perceptible output based on the selected data messages.

Advantageously according to some embodiments, the method further comprises processing the selected data messages at the second wireless element so as to produce user-perceptible output based on payload data in the selected data messages.

Advantageously according to some embodiments, the method further comprises, prior to reading the configuration data at the first wireless element, the step of bringing the group token within a reading distance of the reader of the first wireless element. Advantageously according to some embodiments, the method further comprises, prior to reading the configuration data at the second wireless element, the step of bringing the group token within a reading distance of the reader of the second wireless element. Advantageously, the reading distance is a pre-determined proximity between the group token and the first and/or second wireless elements. Thereby, the above discussed advantages of a proximity reading technique are achieved.

Further according to some embodiments, the method further comprises reading, at the first and/or second wireless element, a group label stored on the group token and setting a corresponding status indicator in said first and/or second wireless element.

Further according to some embodiments, the method further comprises reading, at the first and/or second wireless element, programmed instructions stored on the group token and executing the programmed instructions at said first and/or second wireless element.

Advantageously according to some embodiments, executing the programmed instructions comprises generating user-perceptible output. Furthermore, executing the programmed instructions may comprise performing one or more routines selected from the group of: a reset routine, an initialization routine, a testing routine, and a functionality demonstration routine. Further according to some embodiments, executing the programmed instructions is performed upon reading group configuration data from the group token.

### BRIEF DESCRIPTION OF THE DRAWINGS

Embodiments of the disclosure will be described in more detail in the following in connection with the appended drawings.

FIG. 1 schematically shows a first scenario of grouping of wireless elements in a toy or educational system according to an embodiment of the disclosure.

FIG. 2 schematically shows a second scenario of grouping of wireless elements in a toy or educational system according to an embodiment of the disclosure.

FIG. 3 schematically shows a third scenario of grouping of wireless elements in a toy or educational system according to an embodiment of the disclosure.

FIG. 4 schematically shows a fourth scenario of grouping of wireless elements in a toy or educational system according to an embodiment of the disclosure.

FIG. 5 schematically shows an embodiment of a wireless element for use in a toy or educational system according to an embodiment of the disclosure;

FIG. 6 schematically shows a plurality of separate broadcast groups operated in parallel in a toy or educational system according to an embodiment of the disclosure.

FIG. 7 schematically shows a plurality of separate broadcast groups operated in parallel within a master broadcast group in a toy or educational system according to an embodiment of the disclosure.

FIG. 8 shows steps of configuring a first wireless element comprising a transmitter for operation in a broadcast group.

FIG. 9 shows steps of configuring a second wireless element comprising a receiver for operation in a broadcast group.

FIG. 10 shows steps of operating a first wireless element comprising an input device in a broadcast group.

FIG. 11 shows steps of operating a second wireless element comprising an output device in a broadcast group.

FIG. 12 shows modular elements of a prior art toy construction system.

### DETAILED DESCRIPTION

As discussed above, a plurality of wireless elements of a toy or educational system may be used and arranged together for a playful and educational experience. Such playful and educational experience may involve many users at the same time in many different settings. Common to all these settings involving multiple users is a need to facilitate selective interaction within one subset of wireless elements, e.g. wireless elements belonging to one user group or construction model, without interfering with other subsets of wireless elements, e.g. wireless elements belonging to other users, or another construction model.

The above-mentioned challenges may be solved according to embodiments of the present disclosure by configuring the wireless elements to communicate with each other in a grouped broadcast network facilitating fast and instantaneous sharing of data, without the need of complying with complex registration or pairing protocols. More particularly, the broadcast is selective within broadcast groups, which are configured in a simple and effective manner using respective group tokens.

As further discussed in more detail in the following, embodiments of the disclosure allow for operating a plurality of wireless elements in broadcast groups, the wireless elements at least including one or more transmitters and one or more receivers. A broadcast group is defined by using a group token carrying group configuration data. To read the configuration data, a wireless elements comprises a reader adapted to read the configuration data, when the group token is brought in close proximity of the wireless element using near field communication technology (NFC), an optical data reader, or the like. The required proximity is a reading distance.

The data messages may be broadcast using one or more data channels of a wireless communication infrastructure, such as infrastructure compliant with Bluetooth 5, Bluetooth BLE, ZigBee, Z-wave, or a similar radiofrequency broadcast infrastructure.

When the wireless elements are assigned to a given broadcast group, the transmitters label broadcast data messages with the corresponding group identifier, which may then be used by the receivers in the broadcast group to select the data messages destined for them. Thereby, a selective transmission is facilitated for the selective distribution of data messages from one or more transmitters to one or more receivers, only within the broadcast group. While the receivers may receive any data message broadcast through the one or more data channels, the receivers only process the selected messages, thereby avoiding potential interference from other broadcast groups in the vicinity, and reducing waste of processing power. Such a grouped broadcast is particularly useful in the context of toy or educational systems, e.g. a classroom setting where multiple users or groups of users may operate next to each other, and where each user or user group uses a plurality of wireless elements that are configured to interact with each other, e.g. in an educational assembly, or in a game play set-up, as also discussed elsewhere herein.

Referring to FIGS. 1-4, the process of defining broadcast groups in embodiments of a toy or educational system according to the disclosure is now explained.

FIG. 1 shows schematically a first scenario of grouping wireless elements in an embodiment of a toy or educational system according to the disclosure. The system comprises a group token 1 carrying configuration data 10, including a unique identifier 101 of the group token 1 and a corresponding group label 102. The group configuration data 10 may further comprise programmed instructions 103. The system further comprises wireless elements 5a-5e, each wireless element 5a-5e being adapted to read configuration data 10 from the group token 1 when the group token is brought near the wireless element, within a reading distance thereof, as indicated in the drawing by a double arrow. While the number of wireless elements 5a-5e in the set shown in FIG. 1 is five, the skilled person will understand that any number of wireless elements 5a-5e may be chosen to be included in a given set, such as based on considerations regarding a desired level of complexity of the provided set. In the scenario shown in FIG. 1, a first broadcast group 100 is defined by means of a first group token 1.

To define a broadcast group 100, a subset of the wireless elements 5a-5e, here represented by the three wireless elements 5a-5c, is selected for reading group configuration data 10 from the group token 1. While the number of selected wireless elements 5a-5c in the subset shown in FIG. 1 is three, the skilled person will understand that any number of wireless elements 5a-5c may be selected to be included in a given subset, such as based on considerations regarding a desired level of complexity of the provided subset. The group token 1 is brought within a reading distance of the selected wireless elements 5a-5c, thereby automatically initiating a process of reading configuration data 10 from the group token 1. The configuration data 10 read includes at least the unique identifier 101, or a distinctive part thereof. Upon reading configuration data 10 from the group token 1, each of the wireless elements 5a-5c determines a corresponding group identifier 105 and sets the wireless element 5a-5c to the determined group identifier 105, thereby assigning the selected wireless elements 5a-5c to the broadcast group 100.

The wireless elements 5d, 5e not selected for the group 100 remain unaffected.

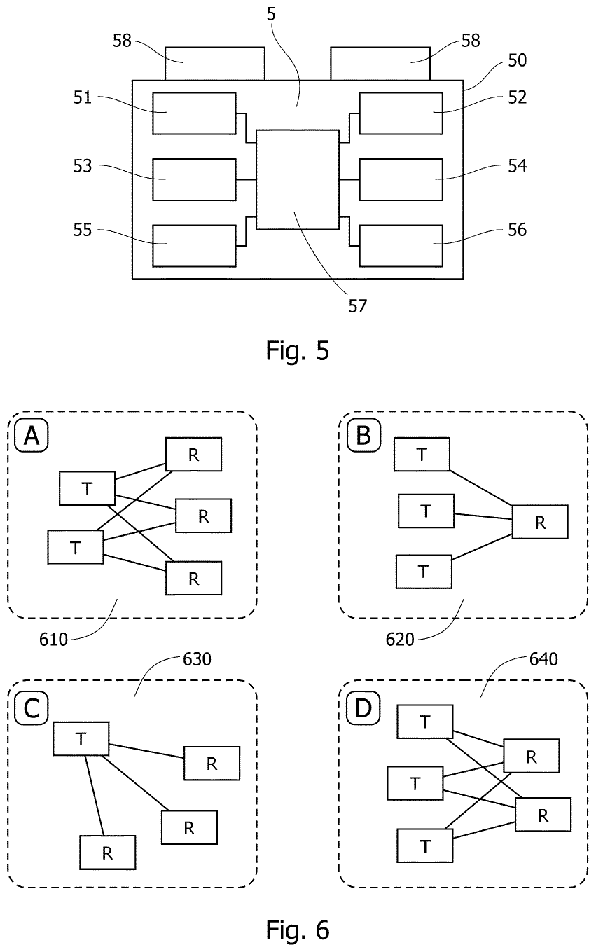

The wireless elements 5a-5e include a transmitter module and/or a receiver module (see for example in FIG. 5). The wireless elements 5a-5e can thus act as transmitters, as receivers, or as both transmitters and receivers, depending on their configuration. The selected wireless elements 5a-5c of a given group 100 include at least a transmitter and at least a receiver. When including the selected wireless elements 5a-5c comprising a transmitter module in a broadcast group 100, the selected wireless elements 5a-5c are configured to include the group identifier 105 in messages broadcast by the transmitter module. Correspondingly, the selected wireless elements 5a-5c comprising a receiver module are configured to select received messages by the group identifier 105 included in the messages. The selected wireless elements 5a-5c are thus configured as members of the broadcast group 100.

According to some embodiments, a selected wireless element 5a-5c overwrites an existing configuration of said wireless element 5a-5c, when reading new configuration data 10 from group token 1. Configuring a wireless element 5a-5c by a group token 1 may cause a reset of the wireless element 5a-5c to a default state. According to some embodiments, the default state may be selected based on configuration data 10 read from the group token 1.

According to some embodiments, reading new configuration data 10 from a group token 1 presented to a selected wireless element 5a-5c adds a new configuration to an existing configuration, as further detailed below. Conceivably, presenting a group token to a wireless element may also cause removal of a configuration from the setup of the wireless element. In so far any such configuration operations are specific or non-standard for a given toy or educational system, said configuration operations may be associated with a distinctive gesture and/or associated with a specific token adapted for specific operations. By way of example, a distinctive gesture may include double tapping the wireless element with the group token, or any other distinctive gesture. A specific token may be one or more of a configuration addition and/or removal token, a group-reset-token, or a generic reset-all-token.

The configuration data 10 read by the wireless elements 5a-5c may further include the group label 102. Even though being associated with a given group identifier 101, the group label 102 may be less distinctive than the group identifier 101. The group label 102 is mainly conceived as a way to allow a user to easily distinguish between different group tokens and the corresponding groups. A user-readable representation of the group label 102 is therefore typically also provided on the group token 1. By way of example, the group label 102 may be one or more of a color, a symbol, a character, a number, a word, a name, a theme, or the like, or any combination thereof. Preferably, the group label 102 is distinctive for each different group token 1 in a set, and may be presented graphically and/or in textual form. Furthermore, the group label 102 may be represented visibly and/or tactile on the outside of the group token for reasons of accessibility to a broad user group. Upon reading the group label 102, the wireless element 5a-5c may then provide a user-perceptible output representative of the group label at a status indicator 52a-52c of the wireless element 5a-5c.

The configuration data 10 read by the wireless elements 5a-5c may also include programmed instructions 103. Upon reading the programmed instructions 103, the wireless element 5a-5c may proceed to execute at least some of the programmed instructions 103 and/or may store at least some of the programmed instructions 103 for later use, depending on the programmed instructions 103 and/or the configuration of the wireless element 5a-5c.

By way of example, the programmed instructions may include configuration instructions, initialization instructions, resetting instructions, functionality testing instructions, demo function execution instructions; or the like. Furthermore by way of example, the programmed instructions may result in a user perceptible output from the wireless elements 5a-5c, e.g. a status indication corresponding to a status of reading and/or execution of programmed instructions 103.

Advantageously, reading configuration data 10 from the group token 1 may be performed using a proximity reading technique, which requires bringing the group token 1 within a reading distance of the selected wireless elements 5a-5c. A reading distance for proximity reading may typically be up to a few centimeters, such as less than 10 cm, or less than 5 cm, or even within 2 cm.

According to some embodiments, the reading may be associated with placing the wireless elements in a holder or a gesture of “tapping” or “baptizing” the wireless element or group of wireless elements 5a-5c selected from the plurality of wireless elements 5a-5e with the group token 1, or otherwise bringing the group token 1 close to the wireless elements 5a-5c to be configured. Said “tapping” or “baptizing” gesture is typically performed by a master-user initializing the system. Besides being easy and intuitive, such a gesture of bringing the group token 1 close to the wireless element or group of selected wireless elements 5a-5c may also be used as an educational manifestation of the initialization process vis-á-vis the participating users.

Alternatively or in addition thereto, the reading may also be associated with a gesture of sorting wireless elements in a sorting box. For example, the group token 1 may be integrated in such a sorting box, in a lid for such a sorting box, or may be attached to either of those, in such a manner that wireless elements in the sorting box are configured according to the group token 1 of the sorting box. For example, the group token 1 may be placed in an entry opening of the sorting box, where the selected wireless elements 5a-5c read the configuration data 10 on passing when sorted through that opening, or the reading distance may be adapted to allow for reading the group token 1 as long as the selected wireless elements 5a-5c are placed inside the box.

Such a gesture based configuration and/or initialization is facilitated by requiring any suitable proximity reading technology, which allows the wireless elements 5a-5e to selectively read the group token 1 only when the reading process complies with predetermined proximity criteria, and discard any reading process not complying with the pre-determined proximity criteria. Such predetermined proximity criteria may include one or more of a pre-determined reading distance, a predetermined threshold signal strength, a time limit, or the like. Requiring a proximity reading technology also ensures that the configuration data transfer can be performed by a user gesture in a controlled manner, without accidental cross-talk to other wireless elements 5d-5e that are not to be included in a given group of selected wireless elements 5a-5c.

The proximity reading technique may be based on inductive coupling techniques. For example, a wireless element (5a-5e) may use an inductive nearfield communication technology (NFC) to read the group token, such as RFID, where the group token 1 may advantageously be a passive or powerless tag. Alternatively or in addition thereto, an optical proximity reading technology, such as an optical tag or optical code scanning technology may be employed, such as a one or two dimensional bar code reader, or any other optical code reader configured to be proximity sensitive.

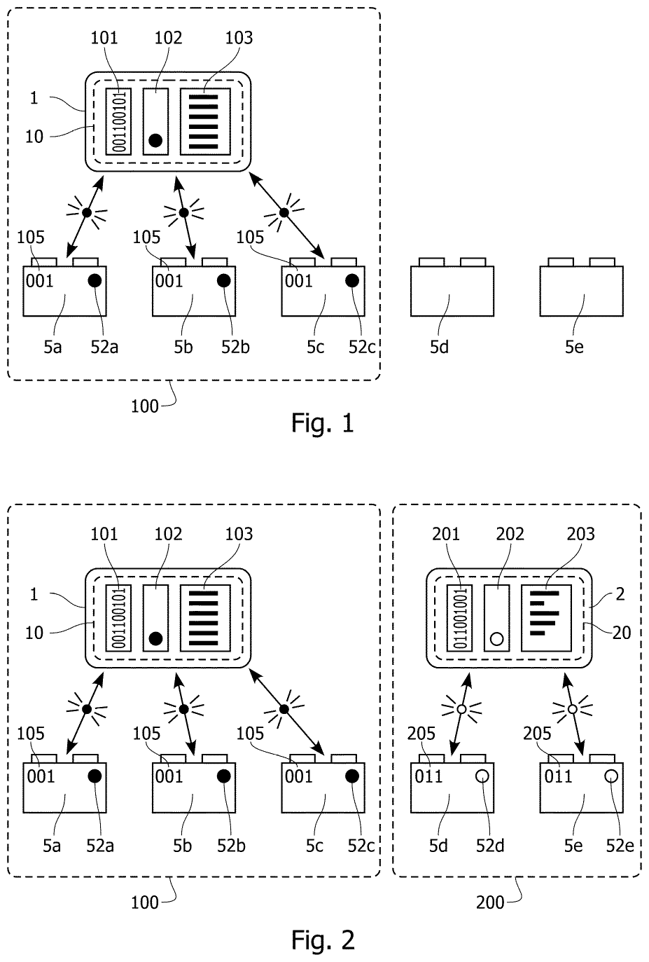

FIG. 2, shows schematically a second scenario of grouping the wireless elements (5a-5e) of the toy or educational system of FIG. 1. A first broadcast group 100 is defined and configured using the first group token 1, as described above with respect to FIG. 1. The system further comprises a second group token 2 carrying second configuration data 20, including a unique identifier 201 of the second group token 2 and a corresponding second group label 202. The group configuration data 20 may further comprise second programmed instructions 203. The second group token 2 may then be used in an analogous manner as described above with respect FIG. 1 for the first group token 1, in order to define a second broadcast group 200, by selecting a second subset of wireless elements 5d, 5e, assigning a second group identifier 205 derived from the unique identifier 201 of the second group token 2 to the second subset of wireless elements 5d, 5e, and configuring the wireless elements 5d, 5e of the second subset as members of the second broadcast group 200. While the number of selected wireless elements 5d, 5e in the second subset shown in FIG. 2 is two, the skilled person will understand that any number of wireless elements 5d, 5e may be selected to be included in a given subset, such as based on considerations regarding a desired level of complexity of the provided subset.

As in the first scenario above, the wireless elements 5d, 5e not selected for the first broadcast group 100 remain unaffected by the grouping process using the first group token 1. Furthermore, the wireless elements 5a-5c not selected for the second broadcast group 200 remain unaffected by the grouping process performed using the second group token 2. The two broadcast groups 100, 200 are therefore separate, and may be operated independent of each other.

As above, upon reading group labels 102, 202 from configuration data 10, 20 on the group tokens 1, 2, the wireless elements of the corresponding broadcast group 100, 200 may provide a user-perceptible output representative of the corresponding group label at a status indicator 52a-52e of the wireless element 5a-5e. Furthermore, upon reading programmed instructions 103, 203 from configuration data 10, 20 on the group tokens 1, 2, the wireless elements of the corresponding broadcast groups may proceed to execute at least some of the programmed instructions 103, 203 and/or may store at least some of the programmed instructions 103, 203 for later use, depending on the programmed instructions 103, 203 and/or the configuration of the wireless elements 5a-5e.

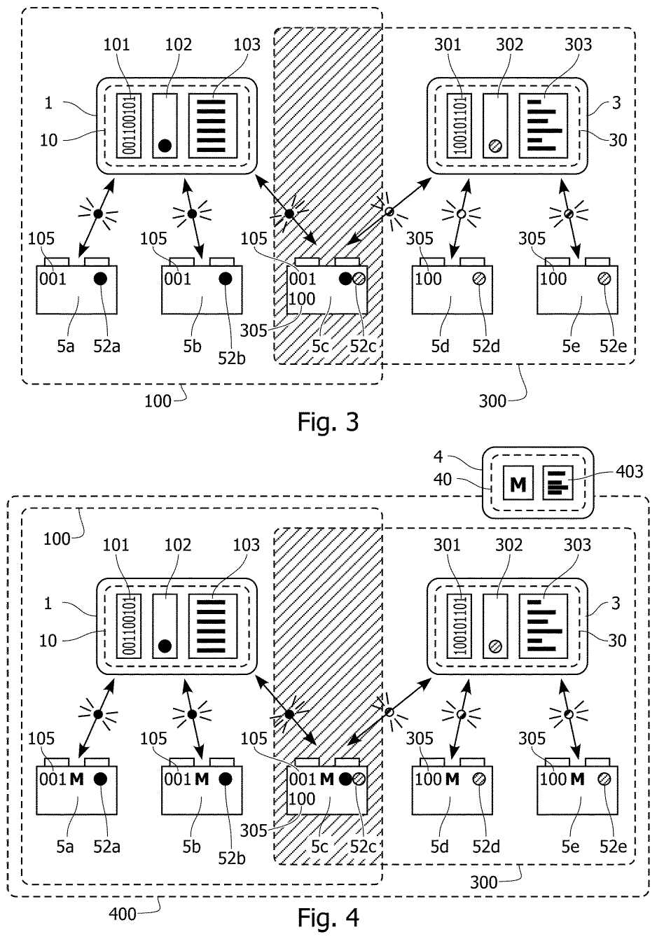

FIG. 3 shows schematically a third scenario of grouping the wireless elements 5a-5e of the toy or educational system of FIGS. 1 and 2. A first broadcast group 100 is defined and configured using the first group token 1, as described above with respect to FIG. 1. The system further comprises a third group token 3 carrying third configuration data 30, including a unique identifier 301 of the third group token 3 and a corresponding third group label 302. The group configuration data 30 may further comprise third programmed instructions 303. The third group token 3 may then be used in an analog manner as described above with respect FIG. 1 for the first group token 1, in order to define a third broadcast group 300, by selecting a third subset of wireless elements 5c-5e, assigning a third group identifier 305 derived from the unique identifier 301 of the third group token 3 to the third subset of wireless elements 5c-5e, and configuring the wireless elements 5c-5e of the third subset as members of the third broadcast group 300. In distinction from the second scenario described above with respect to FIG. 2, the two broadcast groups 100, 300 of the third scenario overlap with each other as indicated by the hatched intersecting area in FIG. 3. When reading the configuration data from the third group token 3, the existing configuration of wireless elements 5c in the intersecting area is not erased. Instead, assigning and configuring the wireless elements 5c in the intersecting area to the third broadcast group 300 is performed in an additive manner, adding the new group configuration from group token 3 to the existing configuration of the wireless elements 5c from group token 1. The wireless elements 5c in the intersecting area are thus configured for operation in both broadcast groups 100, 300.

While the number of selected wireless elements 5c-5e in the third subset shown in FIG. 3 is three, the skilled person will understand that any number of wireless elements 5c-5e may be selected to be included in a given subset of a set of wireless elements 5a-5e, such as based on considerations regarding a desired level of complexity of the provided subset. Correspondingly, while the number of selected wireless elements 5c in the intersection of the first subset 5a-5c and the second subset 5c-5e shown in FIG. 3 is one, the skilled person will understand that any number of wireless elements 5c may be selected to be included in a given intersection of overlapping subsets (5a-c), (5c-5e) of a given set of wireless elements 5a-5e, such as based on considerations regarding a desired level of complexity of the provided intersection of subsets. Furthermore, while the number of broadcast groups shown in FIGS. 2 and 3 is two, the skilled person will understand that any number of broadcast groups may be defined, such as based on considerations regarding the number of wireless elements available, the number of participants in an event or activity, and/or a desired level of complexity of the event or activity.

As in the first scenario above, the wireless elements 5d, 5e not selected for the first broadcast group 100 remain unaffected by the grouping process using the first group token 1. Furthermore, the wireless elements 5a, 5b not selected for the third broadcast group 300 remain unaffected by the grouping process performed using the third group token 3. However, the two broadcast groups 100, 300 overlap by having a common wireless element 5c. The common wireless element 5c is thus a member of both the first and the third broadcast groups 100, 300. The two broadcast groups 100, 300 are therefore not separate, and may be operated in combination.

Overlapping broadcast groups may be particularly useful in a scenario where the two broadcast groups need to share a common functionality. By way of example, shared functionality may include a transmitter receiving input signals from a clock and be adapted for broadcasting shared timing information to the overlapping broadcast groups. Another example may be a switch coupled to a transmitter allowing to pause or stop activity of all other wireless elements in the overlapping broadcast groups, e.g. for use as a referee or safety button.

Furthermore by way of example, shared functionality may include a wireless element comprising a receiver coupled to a display wherein the receiver is adapted to select messages received from either broadcast group, and may display data received in the selected messages according to the broadcast group where the selected messages come from. This may be useful e.g. for providing a real time score board in a competition of teams, each team having a respective subset of wireless elements (5a, 5b), (5d, 5e) used to perform certain tasks and earn a corresponding score. Once a score is earned, the data may be broadcast within the broadcast group 100, 300 of the team, and received and selected for display by the common wireless element 5c with receiver and display functionality, which is a member of both broadcast groups 100, 300.

As above, upon reading group labels 102, 302 from configuration data 10, 30 on the group tokens 1, 3, the wireless elements of the corresponding broadcast group 100, 300 may provide a user-perceptible output representative of the corresponding group label 102, 302 at a status indicator 52a-52e of the wireless element 5a-5e. Furthermore, upon reading programmed instructions 103, 303 from configuration data 10, 30 on the group tokens 1, 3, the wireless elements 5a-5e of the corresponding broadcast groups 100, 300 may proceed to execute at least some of the programmed instructions 103, 303 and/or may store at least some of the programmed instructions 103, 303 for later use, depending on the programmed instructions 103, 303 and/or the configuration of the wireless elements 5a-5e.

FIG. 4 shows schematically a fourth scenario of grouping the wireless elements 5a-5e of the toy or educational system of FIGS. 1-3. The fourth scenario includes the third grouping scenario as described above with respect to FIG. 3, which is nested within a master broadcast group 400 adapted to include all wireless elements 5a-5e of the two overlapping broadcast groups 100, 300. While the fourth scenario shows a master broadcast group 400 enclosing two overlapping broadcast groups 100, 300, the skilled person will understand that any number and combination of overlapping and separate broadcast groups may be nested within a common master broadcast group, said master broadcast group being adapted to include all wireless elements in the defined broadcast groups. According to some embodiments, the master broadcast group 400 may be defined using a master group token 4, comprising a master group configuration data 40, which including a master group identifier “M” and optional programmed instructions 403, which may be used in a similar manner as described above for the programmed instructions 103, 203, 303 that may be included in the group configuration data 10, 20, 30 of the group tokens 1, 2, 3. By way of example, the master broadcast group 400 may be defined additively to include the master group identifier “M” in the wireless elements 5a-5e of all broadcast groups 100, 300 in a similar manner as the additive configuration procedure described above with respect to FIG. 3, for configuring the common wireless elements 5c of the overlapping broadcast groups 100, 300. Such a master broadcast group may be useful for tasks requiring interaction with the wireless elements of all broadcast groups, such as centrally resetting, initializing, timing, starting, stopping, pausing, or monitoring any activity of the wireless elements in all broadcast groups.

As above, upon reading group labels from configuration data 10, 30, 40 of the group tokens 1, 3, 4, the wireless elements of the corresponding broadcast group 100, 300, 400 may provide a user-perceptible output representative of the corresponding group label at a status indicator 52a-52e of the wireless element 5a-5e. Furthermore, upon reading programmed instructions from configuration data 10, 30, 40 on the group tokens 1, 3, 4, the wireless elements 5 of the corresponding broadcast groups 100, 300, 400 may proceed to execute at least some of the programmed instructions 103, 303, 403 and/or may store at least some of the programmed instructions for later use, depending on the programmed instructions and/or the configuration of the wireless elements 5a-5e.

FIG. 5 shows schematically a wireless element 5 adapted for use in an embodiment of a toy or educational system according to the disclosure. Generally, the wireless element 5 includes a group token reader 51 adapted to read configuration data from a group token. The wireless element 5 further includes a processor 57 configured to set a group identifier based on configuration data read from a group token. The wireless element 5 may further include a status indicator 52 adapted to provide a user-perceptible output according to a group status of the wireless element, wherein the processor 57 may be configured to set the group status based on configuration data read from a group token. More particularly, the group status indicator 52 may be controlled by the processor 57 to provide a status output corresponding to a group label, such as light emission in a color corresponding to a group label specified as a color.

Furthermore, the wireless element 5 may comprise an input device 53 adapted to collect input, such as user input and/or sensor input or data from an external data source, such as for providing timing data or trigger instructions. An input device 53 may include a sensor adapted to sense physical quantities and provide corresponding sensor data representative of the sensed physical quantity, such as mechanical, electrical, and optical quantities, or a combination of these. By way of example, such sensors may include a switch, a keyboard, a position sensor, a proximity sensor, a motion sensor, an acceleration sensor, a pressure sensor, a light sensor, a temperature sensor, a touch sensor, a microphone, or the like. The input device 53 is further adapted to pass any collected input to the processor for further handling.

The wireless element 5 may comprise a transmitter module 54 adapted to broadcast data messages through one or more channels of a wireless communication infrastructure, such as Bluetooth, or similar. The transmitter module 54 is furthermore operationally coupled to the processor 57, which controls operation of the transmitter module 54 and provides the data messages to be broadcast. Furthermore, the wireless element 5 may comprise a receiver module 55 adapted to receive data messages through the one or more channels of a wireless communication infrastructure, such as Bluetooth, or similar. The receiver module 55 is furthermore operationally coupled to the processor 57, which controls operation of the receiver module 55, and handles any received data messages, including selection of data messages by group identifier, and any further processing of selected data messages. Furthermore, the wireless element 5 may comprise a function device 56 adapted to provide a user perceptible output, such as motion, light, sound, image or video display, audio or similar. The function device is operationally coupled to the processor 57, which controls its operation. For example, the processor 57 may control the operation of the function based on any programmed instructions or data collected from the reader 51 or the receiver 55. The wireless element 5 is thereby adapted for operation in a grouped broadcast network.

Generally, the wireless element 5 may be adapted to transmit data messages, to receive data messages, or both. Generally, the wireless element 5 may be adapted to collect input, to generate user-perceptible output, or both. While the wireless element 5 shown schematically in FIG. 5 includes all the above-mentioned components, it will be appreciated that a reader 51 and a processor 57 are present in all wireless elements, together with an appropriate power supply (not shown in the drawing), whereas the other components 52, 53, 54, 55, 56 may or may not be present in a given wireless element 5. The optional components include the status indicator 52, the input device 53, the transmitter module 54, the receiver module 55, and the function device 56. In practice, the optional status indicator 52 is very useful in order to give a user an immediate feed-back on the successful configuration of the wireless element 5 by means of a group token.

Generally, the processor 57 of a wireless element 5 includes programmed instructions controlling the behavior of the wireless element 5. For example, the programmed instructions on an input element may control the frequency of data collection, the conversion of the input into input device output data, and the parsing of the input device output data in a data message for broadcast by the transmitter module 54. The programmed instructions on a receiver element may control the response to received data messages, and the details of the response output, such as a motion pattern or speed, or a color and duration of a light emission or of a sequence of light pulses. The programmed instructions may be written to the wireless element 5, modified, or replaced, in order to program the behavior of the wireless element 5. The wireless element 5 may read programmed instructions included in configuration data from a group token. Alternatively or in addition thereto, the wireless element 5 may be configured to read such programmed instructions from a dedicated programming token that may be provided separately. Furthermore, the toy or educational system may provide a programming interface operated on a separate computing device, such as a personal computer, a tablet computer, a mobile phone, or a similar smart device, which may connect to the processor 57 of the wireless element 5 through the reader device 51, through transmitter and receiver modules 54, 55, or through a dedicated programming port (not shown). Programming of the wireless element 5 may also be performed via the intermediate of a rewritable group token or programming token, by creating a program on a separate computing device, transferring the program from the separate computing device to the group token or programming token, and then read the program from the token to the wireless element 5 using the reader 51 of the wireless element 5.

In a typical configuration, a wireless element 5 will at least include either a transmitter module 54 or a receiver module 55. Furthermore, in a typical configuration a wireless element 5 comprising an input device 53 will also include a transmitter module 54 so as to be able to share the collected input with other wireless elements of a broadcast group. A wireless element 5 comprising a function device 56 can also include a receiver module so as to be able to control the function device 56 responsive to programmed instructions and/or data shared between the wireless elements of a broadcast group.

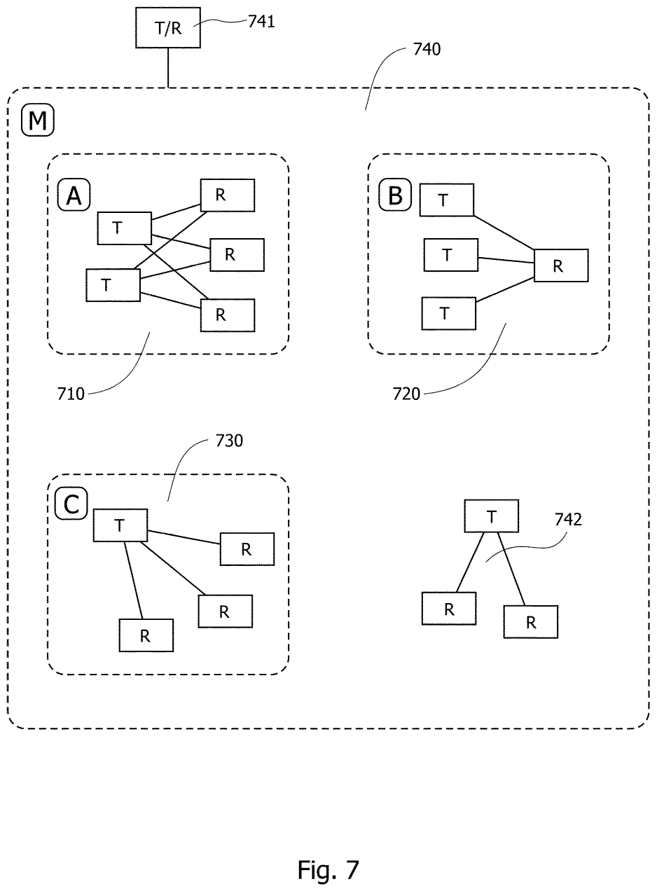

FIGS. 6 and 7 schematically show two different constellations for arranging multiple broadcast groups that are operated in combination. In overview, the broadcast groups and their constellation are defined in an initial set-up phase of an educational event or play activity by the grouping procedure with a group token applied to an embodiment of the toy or educational system according to the disclosure. However, in some embodiments, the operational constellations may also be modified dynamically later on by adding one or more wireless elements to a broadcast group, removing one or more wireless elements from a broadcast group, and/or re-assigning one or more wireless elements to a different broadcast group using adequate group tokens.

When defining a broadcast group, the same, or at least corresponding, procedure of assigning a group identifier by using a group token is applied to all wireless elements participating in said broadcast group, including both transmitters and receivers. Thereby, a high flexibility and modularity is achieved for defining and redefining broadcast group constellations in an easy and effective manner.

FIGS. 6 and 7, by way of example, only show two different constellations with a limited number of wireless elements in a limited number of broadcast groups It will be appreciated that the variety of constellations that can be formed is, of course, not limited to the two constellations shown. Rather, the flexibility and ease of use of the toy or educational system according to embodiments of the disclosure facilitates varying the constellations from fully separate broadcast groups (e.g. FIG. 6), potentially with a large number of broadcast groups being operated in parallel, to overlapping broadcast group constellations, and nested broadcast groups (e.g. FIG. 7), or any combinations thereof.

FIG. 6 shows a typical constellation of operating an embodiment of a toy or educational system using broadcast grouping, where subsets of wireless elements 5 are assigned to separate broadcast groups 610, 620, 630, 640 by means of respective group tokens A, B, C, D.

As mentioned above, in some embodiments, a fully separate broadcast grouping may even be imposed on a system level such that one or more, or each of the wireless elements 5 is configured to only accept assignment to one broadcast group 610, 620, 630, 640 at a time. Thereby, a radically simple constellation is imposed in a manner, which is easy to understand by a user, thereby lowering an entry barrier for a successful and satisfying user experience.

As also mentioned above, operation in separate broadcast groups 610, 620, 630, 640 may be combined with a simple broadcast protocol architecture, where any payload data is also transmitted in the same one or more communication channels as the grouping information. For example, grouping information (e.g. a group identifier) may be included in a header portion of a broadcast message and associated payload data may be attached in a body portion of the broadcast message as discussed elsewhere herein. The grouping information and the associated payload data may e.g. be broadcast by transmitting wireless elements T on multiple broadcast channels in parallel, for example using one or more advertising channels of a wireless communication infrastructure, such as Bluetooth, BLE, or similar. The receiving wireless elements R may then be configured to monitor multiple broadcast channels in parallel, such as the above-mentioned advertising channels, for relevant messages, i.e. messages having matching group information, and if a match is found, to also receive any associated payload data for processing. Furthermore, such a simplified broadcast protocol may prioritize distributing payload data with a predetermined maximum length and/or to distributing response time critical payload data. More extensive data and/or data that is not (or less) critical to responsiveness may then be transferred through other channels and/or communication modes. For example in some embodiments, firmware update data or otherwise lengthy data may be exempted from broadcast through such grouped broadcast channels. Instead, such data transfers may be transferred from a processing device (e.g. a smart device or a personal computer, not shown in FIG. 6) to a wireless element in a paired or connected communication mode. A radically simplified approach imposing separate broadcast groups 610, 620, 630, 640 thus also allows to reduce lag in interaction response among grouped wireless elements T, R despite potentially severe restrictions in processing power and communication bandwidth. Thereby a satisfying user experience can be achieved even under the severe cost and performance limitations inherent to toy or educational systems.

Each broadcast group 610, 620, 630, 640 comprises at least one wireless element 5 with a transmitter module T, and at least one wireless element 5 with a receiver module R. While the wireless elements 5 shown in FIG. 6 are shown to be operated either as a transmitter or as a receiver in the respective broadcast groups, it will be appreciated that at least some of the wireless elements 5 may also be operated as both transmitters and receivers, depending on the hardware and configuration of the wireless elements 5. By way of example, the four broadcast groups 610, 620, 630, 640 are defined as follows. The first broadcast group 610 has two wireless elements 5 operating as transmitters T and three wireless elements 5 operating as receivers R, wherein each receiver R is configured to only select data messages received from either of the two transmitters T in the same broadcast group 610. The second broadcast group 620 has three wireless elements 5 operating as transmitters T and one wireless element 5 operating as receiver R, wherein the receiver is configured to only select data messages received from either of the three transmitters T in the same broadcast group 620. The third broadcast group 630 has one wireless element 5 operating as transmitter T and three wireless elements 5 operating as receivers R, wherein each of the receivers R is configured to only select data messages received from the single transmitter T in the same broadcast group 630. The fourth broadcast group 640 has three wireless elements 5 operating as transmitters T and two wireless elements 5 operating as receivers R, wherein each receiver R is configured to only select data messages received from either of the three transmitters T in the same broadcast group 640. More generally speaking, the broadcast groups 610, 620, 630, 640 are separate from each other so that any data messages transmitted by a transmitter of one broadcast group 610, 620, 630, 640 are only selected for further handling when received by receivers of the same broadcast group 610, 620, 630, 640.

While receivers R of the other broadcast groups may receive said data messages, the other receivers R will not select the messages for further processing, since the group identifier of the received data message does not match the group identifier of the receiver R.

It will be appreciated that all receivers R participating in a given broadcast group 610, 620, 630, 640 will select all data messages received from transmitters T of the same broadcast group for further processing. Nevertheless, a receiver may still be configured to subsequently ignore instructions or data in selected messages that are not relevant for execution at the wireless element 5 of the receiver R. For example, an instruction concerning the emission of a lighting sequence may be executed when received at a wireless element 5 having a function device with light emitting functionality, but may be ignored by a wireless element 5 not having this functionality (e.g. a wireless element 5 having a motor or a loudspeaker as a function device). However, this selection of relevance of selected messages is performed after analyzing the content of the selected message. While this still creates some redundancy in the processing of data messages at each receiving wireless element 5, the total amount of processing required is significantly reduced in a constellation with broadcast grouping as compared to a constellation without broadcast grouping, since not all received messages need to be processed, but only those of the received data messages that have been selected by their matching group identifier.

FIG. 7 shows another constellation of operating an embodiment of a toy or educational system using broadcast grouping, where subsets of wireless elements 5 are assigned to separate broadcast groups 710, 720, 730 by means of respective group tokens A, B, C. By way of example, the broadcast groups 710, 720, 730 correspond to the broadcast groups 610, 620, 630 as described above with respect to FIG. 6. However, in contrast to the constellation of fully separate broadcast groups 610, 620, 630, 640 as shown in FIG. 6, the constellation shown in FIG. 7 further includes a master group 740 defined by means of a master group token M. The master group 740 may comprise transmitter and/or receiver modules at a central terminal 741 communicating with the broadcast group 740, and a fourth subset 742 of wireless elements 5 with at least one transmitter T and at least one receiver R. The three otherwise separate broadcast groups 710, 720, 730 are all nested within the master group 740 by means of a master group token M. As a consequence, any of the wireless elements 5 operated as receivers R in any of the broadcast groups 710, 720, 730, 740 will also select all received data messages including the master group identifier, which may originate from the central master group terminal 741, or any of the master group transmitters in the fourth subset 742.

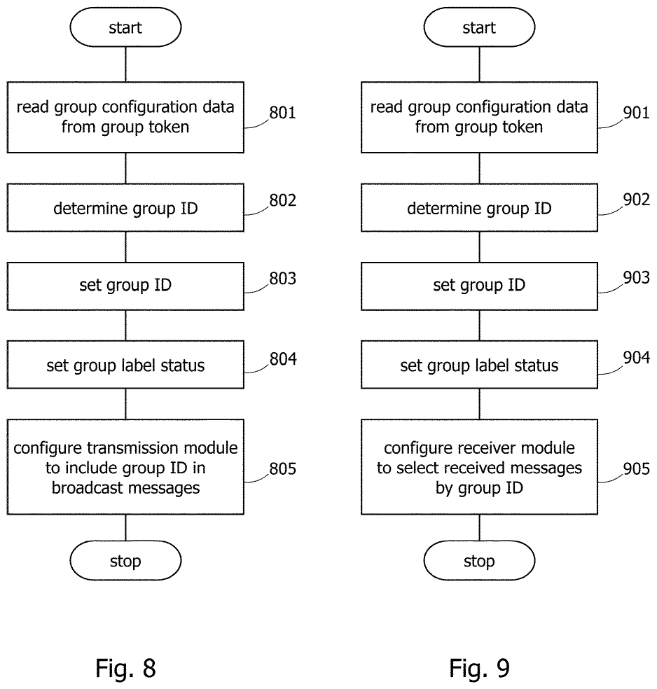

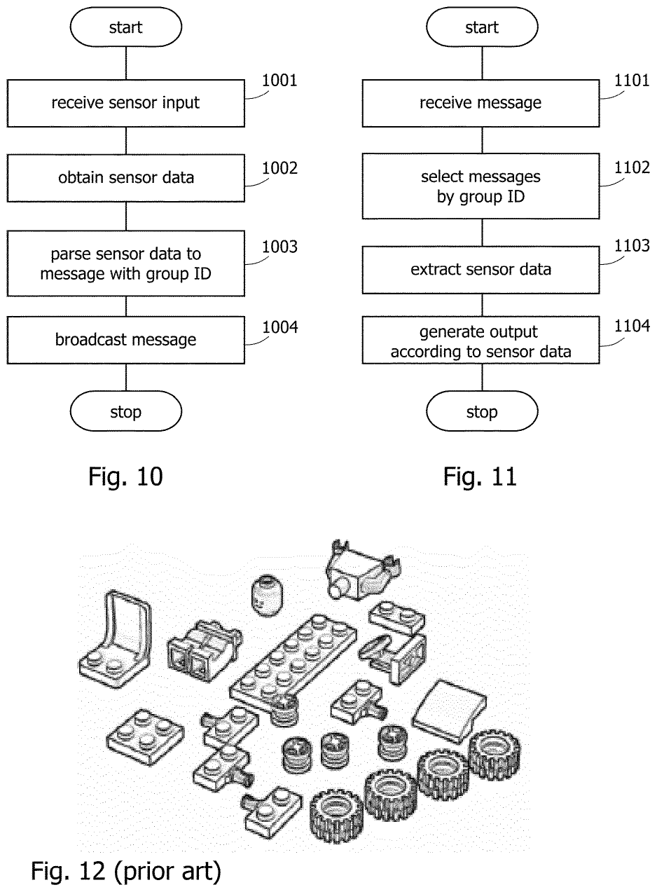

Referring to FIGS. 8-11, method steps of procedures for grouping wireless elements 5 in broadcast groups (FIGS. 8 and 9) and of operating wireless elements 5 in such a broadcast group (FIGS. 10 and 11) are shown. Preferably, the subset of wireless elements 5 of each broadcast group comprises at least a transmitter element and at least a receiver element.

FIG. 8 shows method steps of a procedure of configuring a wireless element 5 comprising a transmission module as a member of a broadcast group by means of a group token. In step 801, the wireless element comprising a transmitter module reads group configuration data from a group token as described elsewhere herein. In step 802, a group identifier is determined, based on the configuration data read from the group token. Typically, the group identifier may be a unique identifier of the group token, such as a unique identifier of an RFID tag included in the group token, or a sufficiently distinctive portion of said unique identifier allowing for distinction between a pre-determined number of different group tokens. In step 803, the group identifier of the wireless element is set to the determined group identifier. In step 804, a group label status of the wireless element is set to a group label included in configuration data read from the group token. The group label status may be useful in order to provide a user-perceptible status indication at a status indicator of the wireless element. The group label indicator is conceived as giving an indication of the group a given wireless element is assigned to. However, the group level may not be distinctive at the same level as the group identifier. Typically, the group label will be sufficiently distinctive to allow for a distinction between different group tokens in a given set. While highly useful from a practical point of view, step 804 is nevertheless optional. A small, a simple, or a low-cost wireless element does not require a status indicator that allows for a user-perceptible indication of the group label. In step 805, the wireless element 5 configures the transmission module (or the processor controlling the transmission module) so as to include the group identifier in all broadcast messages destined to the broadcast group associated with that group identifier.

FIG. 9 shows method steps of a procedure of configuring a wireless element 5 comprising a receiver module as a member of a broadcast group by means of a group token. In step 901, the wireless element comprising a receiver module reads group configuration data from a group token as described elsewhere herein. In step 902, a group identifier is determined, based on the configuration data read from the group token. Typically, the group identifier may be a unique identifier of the group token, such as a unique identifier of an RFID tag included in the group token, or a sufficiently distinctive portion of said unique identifier allowing for distinction between a pre-determined number of different group tokens. In step 903, the group identifier of the wireless element is set to the determined group identifier. In step 904, a group label status of the wireless element is set to a group label included in configuration data read from the group token. The group label status may be useful in order to provide a user-perceptible status indication at a status indicator of the wireless element. The group label indicator is conceived as giving an indication of the group a given wireless element is assigned to. However, the group level may not be distinctive at the same level as the group identifier. Typically, the group label will be sufficiently distinctive to allow for a distinction between different group tokens in a given set. While highly useful from a practical point of view, step 904 is nevertheless optional, e.g. in case a small, a simple, or a low-cost wireless element does not have a status indicator that allows for a user-perceptible indication of the group label. In step 905, the wireless element 5 configures the receiver module (or the processor controlling the receiver module) so as to select received data messages for further handling at the wireless receiver element when the group identifier included in the data message matches a group identifier of the wireless receiver element.

FIG. 10 shows method steps of operating a wireless element 5 in a broadcast group, the wireless element 5 comprising an input device and a transmission module. In step 1001, the wireless element receives input at the input device, such as a sensor input. In step 1002, the processor of the wireless element 5 obtains sensor output data from the input device, i.e. data corresponding to the sensor input. In step 1003, the processor parses the sensor data and/or any programmed instructions associated with the sensor data to a data message and includes the group identifier of the broadcast group. In step 1004, the processor passes the data message to the transmitter module and causes broadcasting of the data message.

FIG. 11 shows method steps of operating a wireless element 5 in a broadcast group, the wireless element 5 comprising a receiver module and a function device. As already discussed elsewhere herein, the function device is adapted to produce user-perceptible output and is controlled by a processor of the wireless receiver element. In step 1101, the wireless element receives a data message at the receiver module. In step 1102, the processor of the wireless element 5 selects the received data message for further processing at the processor, based on a match between the group identifier included in the received data message and a group identifier assigned to the wireless receiver element. If no match is found, the received data message is discarded. In step 1103, the processor analyses the selected data message, and extracts any sensor data and/or any programmed instructions included in the data message. In so far the extracted data and/or instructions are relevant for the function device, the wireless receiver element proceeds to step 1104. In step 1104, the processor controls the function device to generate user-perceptible output, based on the extracted sensor data and/or programmed instructions. In so far the extracted data and/or instructions are relevant for the function device, the process stops.

FIG. 12 shows examples of conventional modular construction elements, that are well known in the art of toy construction systems, and which are equally useful and well-known in the context of construction systems for educational purposes. Such modular construction elements may even include input and/or function devices (not shown). However, the conventional modular construction elements do not include the wireless functionality as described herein. The modular construction elements include coupling members adapted for mechanically connecting the modular construction elements with each other in a detachable manner, so as to construct a toy or educational construction model. The coupling members of the conventional modular construction elements shown by way of example in FIG. 12 may include coupling members using friction engagement, snap-fit engagement, or a combination of both, in order to support a detachable connection between the modular construction elements. Alternatively or in addition thereto, detachable connections may also be formed between modular construction elements using coupling members providing a detachable form-locking positive connection. According to some embodiments, the wireless elements of a toy or educational system as disclosed herein may be modular construction elements that are adapted to be compatible with conventional modular construction elements. Further according to some embodiments, a toy or educational system may further comprise conventional modular construction elements, besides a plurality of wireless elements adapted for modular construction, and one or more group tokens.

The following examples further illustrate the usefulness of embodiments of the present disclosure in an educational context and for creating interactive builds in a highly flexible and intuitive manner.

### EXAMPLES

### Example 1

### Classroom Set

In one example, a classroom set of the toy or educational system may be provided for use in a teaching environment with many students in a classroom working together in separate teams under supervision of a tutor. Here, the wireless elements are grouped to be operated in separate, non-interfering broadcast groups (as also illustrated in FIG. 2).

The classroom set of a toy or educational system may include numerous wireless elements, as well as conventional modular construction elements for toy and educational use. Preferably, at least one or more of the wireless elements are modular construction elements including coupling members that are compatible with coupling members of conventional modular construction elements also provided in the classroom set. The wireless elements both include multiple input elements, each comprising an input device and a transmitter module, and multiple function elements, each comprising a receiver module and a function device.

The classroom set further comprises a plurality of different group tokens, typically in the form of cards with a passive RFID tag inside. Preferably, the group tokens are not formed as modular construction elements, in order to easily distinguish the group tokens from elements to be used by the students for solving a given project. The wireless elements of the set further comprise a reader adapted to communicate with the different group tokens to read data therefrom.

The different group tokens carry respective configuration data, including a unique identifier and a group label. The different group tokens are visually and/or tactile distinguishable from each other, for example by providing a distinct color and corresponding visual and/or tactile markings on the outside of the different group tokens. Preferably, the distinguishable markings of each group token are representative of the group label. For example, the group label may refer to a color (RED, BLUE, YELLOW, GREEN), and the group token may have distinct respective markings corresponding to that color.

The tutor may, according to teaching goals for the class, assign tasks to different teams of students to be solved in a hands-on project. Each of the student teams may be given a number of modular construction elements including a plurality of different wireless elements with different functionalities. The functionalities may include devices for receiving input, such as sensors, switches, or the like, and devices for generating user-perceptible output, such as motors, light emitters, sound emitters, or the like.

The wireless elements of each team are grouped using a different group token for the wireless elements each team. For example, the tutor may “tap” the wireless elements of a first team (team “RED”) with a first group token (group label “RED”), thereby defining a first broadcast group including all the wireless elements of the first team. Optionally, the tutor may verify the correct configuration of the wireless elements as members of the broadcast group with the group label “RED” by observing a status indicator of the wireless elements. The tutor may then “tap” the wireless elements of a second team (team “BLUE”) with a second group token different from the first (group label “BLUE”), thereby defining a second broadcast group including all the wireless elements of the second team (team “BLUE”). The tutor may then proceed accordingly for defining any further broadcast groups (“YELLOW”, “GREEN”, etc.) for any of the further teams in the class in the same manner. Once the broadcast groups are defined, the students may freely combine the wireless elements of the group assigned to their team, and link the functionalities of the wireless elements together in a highly flexible and intuitive manner. The students may thus use the wireless elements as functional building blocks to build a more complex functionality in order to solve the objective of the project. For example, a first wireless element may receive a sensor input, and operate a transmitter module to broadcast the corresponding data in a message to the assigned broadcast group, a second wireless element assigned to the same broadcast group may receive and select the message and trigger operation of a motor to generate an actuator output. Note that the first and second wireless elements may or may not be physically connected to each other, since the wireless elements do not communicate through the tether of a wired connection. For example, a motor arranged in one assembly of modular construction elements may be triggered remotely using a sensor arranged in a second assembly separate from the first assembly. In a more complex project, using multiple sensor elements and a plurality of motor components, together with various conventional modular construction elements, a fully functional wireless remote controlled vehicle can be constructed from a few basic functionalities combined in two separate assemblies, a remote control assembly carrying the sensors configured as user input controls, and a vehicle assembly including motors for propulsion and steering that respond to sensor output data from the remote control assembly.

The wireless elements of each team are grouped in separate broadcast groups to communicate exclusively with the other wireless elements within the same broadcast group. Thereby, multiple teams of students can work on their respective projects in the same location, without interfering with any of the other teams. By defining separate broadcast groups using a group token this is achieved in a highly effective manner without the need of complex pairing routines. Each of the broadcast groups includes one or more transmitters and one or more receivers to allow the wireless elements of the broadcast group to interact. Both transmitters and receivers are configured as members of a given broadcast group using the corresponding group token, thereby defining the broadcast groups in a flexible and effective manner.

The classroom set may further include a reset group token configured to reset the wireless elements to a default state. To that end, the configuration data of the reset group token may comprise programmed instructions, which programmed instructions, when read and executed by a wireless element, cause the reset of the wireless element to a default state. This may be useful to ensure a well-defined default state of all wireless elements, prior to setting up groups of wireless elements for specific tasks. Alternatively or in addition thereto the group configuration data stored on each of the different group tokens may also include programmed instructions for resetting the wireless elements, prior to applying the group specific configuration.

### Example 2

### Functional Subgroups

In a further example, a toy or educational system with multiple wireless transmitter and receiver elements may be used to construct a complex assembly having multiple functional subassemblies, which can be addressed selectively using the grouped broadcast. For example, the complex assembly may include multiple motorized subassemblies driven by multiple wireless actuator elements (receiver elements), each including a receiver and a motor, and controlled in response to sensor data provided by multiple wireless sensor elements (transmitter elements), each comprising a sensor device and a transmitter. The multiple wireless actuator elements and the multiple wireless sensor elements may then be grouped such that a subset of the multiple actuators (receiver elements) associated with a first functional subassembly only respond to a subset of the multiple sensors (transmitter elements) that is also associated with the first functional subassembly.

For example, a complex assembly may include a left subassembly and a right subassembly, each subassembly comprising a set of actuators (receiver elements) that are controlled using a corresponding set of sensors (transmitter elements) associated with the left and right subassemblies, respectively. Note that the set of sensors associated with a subassembly may include sensors that are physically connected to the subassembly (e.g. for autonomous control of the sub-assembly) and/or sensors that are not physically connected to the subassembly (e.g. for remote control of the subassembly).

In order to ensure that the left set of actuators only responds to sensor data from the left set of sensors and that the right set of actuators only responds to sensor data from the right set of sensors, separate broadcast groups for the left and right subassemblies may be defined using two different group tokens. However, there may an additional need for controlling both the left and right subassemblies in synchrony, e.g. in order to implement a remotely controlled emergency stop. This may be implemented in an overlapping broadcast constellation, by providing a wireless input element communicating with both broadcast groups (see e.g. FIG. 3), and by configuring the wireless actuator elements in both subassemblies to respond accordingly. For an emergency stop, the wireless input element may be an ON/OFF switch button that is configured as a member of both broadcast groups, and that in response to operating the switch broadcasts corresponding input device output data (switch state “ON” or “OFF”) to both broadcast groups (left and right). When broadcasting a message carrying “OFF” in both broadcast groups, the wireless receiver modules of the actuators in both subassemblies will select the message, and cause an immediate stop in response to receiving a message carrying “OFF”, in agreement with a programmed configuration of the actuators.

Alternative or in addition thereto, a wireless input element may also be placed in a master group, which may be selected and responded to by all receiver modules of the toy or educational system that are in operation (see e.g. FIG. 4). Such a master group may also be useful in the above-disclosed example regarding a classroom set, for example in order to provide a tutor controlled stop or pausing of all activities, or in order to provide a common master clock to which the student teams may refer when completing their project.

### Example 3

### Remote Control

In a further example, a project may be directed to constructing a functional machine (e.g. a vehicle) and a wireless remote control for controlling the functions of the machine. Each team of one or more students may be handed out a number of wireless input elements (transmitter elements) and a number of wireless motor elements (receiver elements), together with a number of conventional modular construction elements including beams, gears, and wheels, in order to complete the project. Using a different group token for each team, the tutor may configure each of the wireless input elements handed out to a team as members of a broadcast group. This initial configuration may also include reading programmed instructions from the group token, which may configure the behavior of the wireless elements to the specific project.

A team of students may then construct a vehicle and include a wireless motor element for propulsion and a wireless motor element for steering in the assembly. The wireless motor elements include receiver modules and are configured to be controlled in response to respective propulsion control and steering instructions in received data messages. The students may further construct a remote control assembly including: a propulsion control input element, which is programmed to parse propulsion control commands based on input to its input device; and a steering control input element, which is programmed to parse steering control commands based on input to its input device. The propulsion and steering motors as well as the corresponding wireless propulsion control and steering input elements are all grouped within the same broadcast group of the team of students. When a user activates the input elements of the remote control assembly, the wireless input elements broadcast corresponding propulsion control and steering commands in data messages tagged with the group identifier assigned to all the wireless elements of the team. The propulsion and steering motors in the vehicle receive the data messages and select them by matching the tagged group identifier with the group identifier assigned to both wireless motor elements. The processors of the motor elements then interpret the commands included in the data messages and only respond in case the command is relevant to their functionality: the propulsion motor element is configured to only respond to propulsion control commands; and the steering motor is configured to only respond to steering commands. While the processor of a given wireless motor element thus also has to handle commands not directed to this wireless motor elements, the processor still only needs to deal with the limited amount of data messages from within the broadcast group of the team. However, thanks to the grouped broadcast configuration, each of the teams may tinker away, testing and trying their assemblies unaffected of any of the other teams also building remote control vehicles.

Once the teams have successfully completed the first project of creating a remote controlled vehicle, the tutor may issue an add-on task of adding a parking assistant to the remote controlled vehicle. To that end the tutor now hands out a further set of wireless elements, for example including proximity sensor elements (transmitter elements) configured to broadcast proximity measurement data and sound or vibration output elements (receiver elements) configured to produce sound or vibration in response to received proximity measurement data, e.g. when coming within a pre-defined threshold distance of an obstacle. Using the same group token as before, the tutor may dynamically add the further set of wireless elements to the same broadcast group as the first set of wireless motor and input elements. To complete the add-on task, the team of students may then include one or more of the wireless proximity sensor elements in the vehicle, and wireless sound and/or vibration elements in the remote control assembly. When a team drives the vehicle up to an obstacle the wireless proximity senor elements broadcast the proximity measurement data in data messages tagged with the group identifier, which are received and selected by all receiver elements in the broadcast group. Only the wireless sound and/or vibration elements are configured to respond to the received proximity measurement data, and will produce an acoustic alert and/or a haptic vibration feedback in the remote control assembly when the vehicle comes too close to the obstacle.

### Example 4

### User Teams Set

In one example, a user teams set of the toy or educational system may be provided for use in a toy or educational environment with many users working together in separate teams, where the wireless elements are grouped to be operated in separate, non-interfering broadcast groups (as also illustrated in FIG. 2).

The user teams set of a toy or educational system may include numerous wireless elements, as well as conventional modular construction elements for toy and educational use. Furthermore, the wireless elements may also be modular construction elements, and therefore also include coupling members that are compatible with the coupling members of the conventional modular construction elements in the set. The wireless elements both include multiple input elements, each comprising an input device and a transmitter module, and multiple function elements, each comprising a receiver module and a function device.

Alternatively or in addition thereto, the wireless elements may also include one or more microcontrollers and/or other processing devices, such as so-called single board microcontrollers or computers conceived for educational and prototyping purposes, such as single board devices of the Arduino brand (or compatible) with optional accessories, of the Raspberry Pi brand (or compatible) with optional accessories, or any other suitable microcontroller and/or processing device. The microcontroller or processing device may comprise or communicate with a reader and a transmitter and/or a receiver, and may be configured to act as an input element and/or as a function element. For ease of integration with a modular construction system, the microcontroller and/or processing device may be mounted in a housing comprising coupling members that are compatible with the coupling members of the conventional modular construction elements in the set, or may be mounted on dedicated adapter or mounting plates that comprise coupling members that are compatible with the coupling members of the conventional modular construction elements in the set.

The user teams set further comprises a plurality of different group tokens, typically in the form of cards with a passive RFID tag inside. Preferably, the group tokens are not formed as modular construction elements, in order to easily distinguish the group tokens from elements to be used by the users for a given project.

The different group tokens carry respective configuration data, including a unique identifier and a group label. The different group tokens are visually and/or tactile distinguishable from each other, for example by providing a distinct color and corresponding visual and/or tactile markings on the outside of the different group tokens. Preferably, the distinguishable markings of each group token are representative of the group label. For example, the group label may refer to a color (RED, BLUE, YELLOW, GREEN), and the group token may have distinct respective markings corresponding to that color.

The users may team up to solve pre-defined tasks in a hands-on project. Each of the user teams may be given a number of modular construction elements including a plurality of different wireless elements with different functionalities. The functionalities may include devices for receiving input, such as sensors, switches, or the like, and devices for generating user-perceptible output, such as motors, light emitters, sound emitters, or the like.

The wireless elements of each team are grouped using a different group token for the wireless elements each team. For example, a user may “tap” the wireless elements of a first team (team “RED”) with a first group token (group label “RED”), thereby defining a first broadcast group including all the wireless elements of the first team. Optionally, the user may verify the correct configuration of the wireless elements as members of the broadcast group with the group label “RED” by observing a status indicator of the wireless elements. The same or another user may then “tap” the wireless elements of a second team (team “BLUE”) with a second group token different from the first (group label “BLUE”), thereby defining a second broadcast group including all the wireless elements of the second team (team “BLUE”). The users may then proceed accordingly for defining any further broadcast groups (“YELLOW”, “GREEN”, etc.) for any of the further teams in the same manner. Once the broadcast groups are defined, the users may freely combine the wireless elements of the group assigned to their team, and link the functionalities of the wireless elements together in a highly flexible and intuitive manner. The users may thus use the wireless elements as functional building blocks to build a more complex functionality in order to solve the objective of the project. For example, a first wireless element may receive a sensor input, and operate a transmitter module to broadcast the corresponding data in a message to the assigned broadcast group, a second wireless element assigned to the same broadcast group may receive and select the message and trigger operation of a motor to generate an actuator output. Note that the first and second wireless elements may or may not be physically connected to each other, since the wireless elements do not communicate through the tether of a wired connection. For example, a motor arranged in one assembly of modular construction elements may be triggered remotely using a sensor arranged in a second assembly separate from the first assembly. In a more complex project, using multiple sensor elements and a plurality of motor components, together with various conventional modular construction elements, a fully functional wireless remote controlled vehicle can be constructed from a few basic functionalities combined in two separate assemblies, a remote control assembly carrying the sensors configured as user input controls, and a vehicle assembly including motors for propulsion and steering that respond to sensor output data from the remote control assembly.

The wireless elements of each team are grouped in separate broadcast groups to communicate exclusively with the other wireless elements within the same broadcast group. Thereby, multiple teams of users can work on their respective projects in the same location, without interfering with any of the other teams. By defining separate broadcast groups using a group token this is achieved in a highly effective manner without the need of complex pairing routines. Each of the broadcast groups includes one or more transmitters and one or more receivers to allow the wireless elements of the broadcast group to interact. Both transmitters and receivers are configured as members of a given broadcast group using the corresponding group token, thereby defining the broadcast groups in a flexible and effective manner.

The classroom set may further include a reset group token configured to reset the wireless elements to a default state. To that end, the configuration data of the reset group token may comprise programmed instructions, which programmed instructions, when read and executed by a wireless element, cause the reset of the wireless element to a default state. This may be useful to ensure a well-defined default state of all wireless elements, prior to setting up groups of wireless elements for specific tasks. Alternatively or in addition thereto the group configuration data stored on each of the different group tokens may also include programmed instructions for resetting the wireless elements, prior to applying the group specific configuration.

1-16. (canceled)

17. A toy or educational system comprising:
a plurality of wireless elements, wherein at least a first one of the wireless elements comprises a wireless transmitter adapted to broadcast data messages through one or more wireless channels, wherein at least a second one of the wireless elements comprises a wireless receiver adapted to receive data messages through the one or more wireless channels; and
a group token carrying group configuration data;
wherein each of the first and second wireless elements further comprises a reader adapted to obtain group configuration data stored on the group token,
wherein the first wireless element is configured, upon reading group configuration data from the group token, to set a group identifier of the first wireless element to a common group identifier based on the group configuration data read from the group token,
wherein the first wireless element is configured to include the common group identifier in a transmitted data message,
wherein the second wireless element is configured, upon reading group configuration data from the group token, to set a group identifier of the second wireless element to the common group identifier based on the group configuration data read from the group token, and
wherein the second wireless element is configured to select received data messages that include the common group identifier;
whereby the first and second wireless elements are grouped in a broadcast group using the same group token.

18. The system of claim 17, wherein the group token is a radio frequency identification tag and the reader is a radio frequency identification reader.

19. The system of claim 18, wherein the radio frequency identification tag is a powerless tag.

20. The system of claim 17, wherein the group configuration data comprises a unique identifier of the group token and wherein the common group identifier is based on the unique identifier of the group token.

21. The system of claim 17, wherein the group configuration data further comprises a group label, and wherein one or more of the first and second wireless elements comprise a status indicator configured to produce a user-perceptible output indicative of the group label.

22. The system of claim 17, wherein the first wireless element is an input element comprising an input device adapted to produce input device output data representative of an input thereto.

23. The system of claim 17, wherein the second wireless element is a function element comprising a function device and a control circuit adapted to control the function device to produce a user-perceptible output.

24. The system of claim 17, wherein the system is a modular construction system comprising modular construction elements, the modular construction elements comprising coupling elements for detachably connecting the modular construction elements to each other so as to construct a toy or educational construction model.

25. The system of claim 24, wherein the wireless elements are modular construction elements.

26. The system of claim 24, wherein the modular construction system further comprises conventional modular construction elements.

27. The system of claim 17, wherein at least a body portion of the message is encrypted using an encryption key (PSK) comprised in the group configuration data.

28. The system of claim 17, wherein the group token further carries programmed instructions, wherein the first or second wireless element is adapted to obtain the programmed instructions from the group token and to execute the programmed instructions upon obtaining the programmed instructions from the group token.

29. A method of grouping a plurality of wireless elements in a broadcast group using a group token, each of the wireless elements comprising a reader adapted to obtain group configuration data stored on the group token;
wherein a first one of the wireless elements comprises a wireless transmitter adapted to broadcast data messages through one or more wireless channels;
wherein a second one of the wireless elements comprises a wireless receiver adapted to receive data messages through the one or more wireless channels;
the method comprising:
obtaining, at the first wireless element, group configuration data from the group token and setting a group identifier of the first wireless element to a common group identifier based on the group configuration data obtained from the group token;
configuring the first wireless element to include the common group identifier in a transmitted data message;
obtaining, at the second wireless element, group configuration data from the group token and setting a group identifier of the second wireless element to the common group identifier based on the group configuration data obtained from the group token; and
configuring the second wireless element to select received data messages that include the common group identifier;
whereby the first and second wireless elements are grouped in a broadcast group using the same group token.

30. The method of claim 29, further comprising obtaining, at the first or second wireless element, a group label stored on the group token and setting a corresponding status indicator in the first or second wireless element.

31. The method of claim 29, further comprising obtaining, at the first or second wireless element, programmed instructions stored on the group token and executing the programmed instructions at the first or second wireless element.

32. The method of claim 29, further comprising:
prior to obtaining group configuration data at the first wireless element, bringing the group token within a reading distance of the reader of the first wireless element; or
prior to obtaining group configuration data at the second wireless element, bringing the group token within a reading distance of the reader of the second wireless element.

33. A toy system comprising:
a plurality of wireless elements; and
a group token, the group token storing group configuration data having a unique identifier, each wireless element incorporating a reader configured to obtain the group configuration data when the group token is placed within a readable proximity,
wherein:
a first one of the wireless elements is equipped with a wireless transmitter that broadcasts data messages across one or more wireless channels, and a second one of the wireless elements is equipped with a wireless receiver that receives the data messages,
each of the first and second wireless elements being configured, in response to the group configuration data, to adopt a common group identifier derived from the unique identifier of the group token, the first wireless element embedding the common group identifier in its transmitted data messages and the second wireless element processing only data messages carrying the same identifier, such that the first and second wireless elements operate as members of a common broadcast group that selectively exchanges data independent of other wireless elements.

34. The toy system of claim 33, wherein the group token comprises a passive radiofrequency identification tag or a near-field communication tag, and each reader is configured to complete data transfer only when the group token satisfies a predetermined proximity or signal-strength condition.

35. The toy system of claim 33, wherein the group configuration data of the group token further includes a group label, and at least one of the wireless elements comprises a status indicator controlled to produce a user-perceptible output corresponding to the group label.

36. The toy system of claim 33, wherein each wireless element is a modular construction element having coupling members for detachably connecting to other modular construction elements to form a toy or educational model, the wireless transmitter and the wireless receiver communicating within the broadcast group without any wired electrical connection.
